(19) United States
(12) Patent Application Publication
(10) Pub. No.: US 2006/0132953 A1
(43) Pub. Date: Jun. 22, 2006

(54) Magnetic recording medium, magnetic recording/reproducing apparatus, and stamper for manufacturing magnetic recording medium

(75) Inventors: Makoto Asakura, Tokyo (JP); Masatoshi Sakurai, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/212,593

(22) Filed: Aug. 29, 2005

(30) Foreign Application Priority Data
Dec. 22, 2004 (JP) 2004-372093

(51) Int. Cl. G11B 5/09; G11B 5/86

(52) U.S. Cl. 360/48; 360/51; 360/15

(57) ABSTRACT

A magnetic recording medium includes a servo area that has a preamble area where a magnetic portion and a non-magnetic portion for clock synchronization are formed; and a data area where user data is written into. The magnetic portion is different in an occupancy to the preamble area from the non-magnetic portion.

### CROSS-REFERENCE TO RELATED APPLICATIONS

This application is based upon and claims the benefit of priority from the priority Japanese Patent Application No. 2004-372093, filed on Dec. 22, 2004; the entire contents of which are incorporated herein by reference.

### BACKGROUND OF THE INVENTION

1. Field of the Invention

The present invention relates to a magnetic recording medium manufactured by an imprint lithography, a magnetic recording/reproducing apparatus that reproduces data from such magnetic recording medium, and a stamper for manufacturing the magnetic recording medium.

2. Description of the Related Art

Magnetic recording medium such as a hard disk (HD) has a servo area where servo information is recorded for positioning of a magnetic head at a desired track and a desired sector, in addition to a data area where data is writable.

Conventionally, the servo information is recorded after the manufacture of the magnetic recording medium by a servo track writer (STW). However, the increased storage density of the magnetic recording medium makes the servo information recording by the servo track writer excessively time consuming, degrading productivity.

In addition, when the servo information is recorded on a patterned media by the STW, since a data area is formed in advance as a track in the patterned media, the STW must be positioned in an area outside the data area previously formed as a track for the recording of the servo information and such positioning is extremely difficult.

To overcome such inconvenience, a technique is proposed to record the servo information as an embedded pattern of uneven magnetic layer in the patterned media. One proposed patterned media is a discrete track media where a track is formed with a magnetic portion physically separate from each other in a width direction of the track (see Japanese Patent Application Laid-Open No. 62-256225, for example).

In the discrete track media, the magnetic pattern is preferably formed with processed magnetic films in the servo area as well. A generally known manufacturing method of such patterned media utilizes imprint lithography.

According to the imprint lithography, an imprint stamper is fabricated as to have protrusions which form a reverse pattern to the pattern of the magnetic portion on the magnetic recording medium in a manner described below. First, electron beam resist is coated on a master disk, followed by drawing of a predetermined pattern with the electron beam, and a pattern of protrusions and depressions is formed in the electron beam resist by development. Then, with the electroforming on the master disk having such an electron beam resist pattern, a metallic disk is formed and separated to be the imprint stamper. Then, a magnetic recording medium is manufactured according to the imprint lithography, for example, as described below. First, a magnetic film is formed on a substrate followed by coating of a resist. The imprint stamper is pressed onto the resist whereby the surface variations of the imprint stamper are imprinted to the surface of resist. After the removal of the imprint stamper, the resist with imprinted variations is employed as a mask for the formation of the magnetic film, and the magnetic recording medium (patterned media) with a desired magnetic pattern is formed.

The magnetic pattern in the finished product, however, varies from the size of the pattern of surface variations of the imprint stamper and turns into a different size from the imprint stamper. Specifically, when the patterned media is manufactured via the imprint lithography with the imprint stamper on which different patterns are present together, the stress of the resist caused by the imprint stamper varies depending on the ratio of an area without a pattern (depression of the stamper) to an area with a pattern (protrusion of the stamper).

Specifically, when the area occupied by the protrusion in the stamper is smaller, a desired depression of the resist can be more easily achieved with the imprint stamper, whereas in a part of the stamper where the ratio of the protrusion is high, the desired depth of the depression cannot be easily achieved. Hence, the press of the imprint stamper is performed based on an area where the stress is minimum, results in an excessive pressurization in an area the effect of stress is originally high, thereby forming magnetic patterns in different sizes in areas with different ratios of the protrusions to the depressions, i.e., the size of the formed magnetic pattern varies in data area, preamble area, burst area, and address area that have different area ratio occupied by the magnetic portions.

To eliminate such inconvenience, the size of the magnetic pattern in a finish product is previously determined, and the surface variations of the stamper and the processing condition are adjusted accordingly to control the size of the magnetic pattern. Such adjustment, however, is realized only through trial and error, which means that the patterned media with a magnetic pattern that satisfies the required specification is difficult to manufacture and the manufacturing work thereof is cumbersome.

In the conventional patterned media, the magnetic portion occupies approximately 65 to 75% of the data area, whereas in the servo area, the magnetic portion occupies 75% in the burst area, and 50% in the preamble area or the address area. Such significant difference in the ratio of magnetic portion in each area further impedes a reliable pattern imprinting by the imprint stamper. In particular, the magnetic portion occupies 50% of the preamble area which has the longest area length in the servo area, which is significantly smaller than the occupancy of approximately 70% in the data area, which obstructs a reliable pattern imprinting.

Even if the occupancy of the magnetic portion is made uniform over the entire area for the reliable pattern imprinting by the imprint stamper, the amplitude of reproduction signals from the preamble area may become smaller in some areas. In other words, the servo processing function in the preamble area, i.e., a process of clock synchronization consisted of an automatic gain control (AGC) process for automatic adjustment of signal amplitude and a phase-locked loop (PLL) process for signal synchronization, may suffer from errors, to decrease the yield at the use of the magnetic recording medium as a hard disk.

### SUMMARY OF THE INVENTION

According to one aspect of the present invention, a magnetic recording medium includes a servo area that has a preamble area where a magnetic portion and a non-magnetic portion for clock synchronization are formed; and a data area where user data is written into. The magnetic portion is different in an occupancy to the preamble area from the non-magnetic portion.

According to another aspect of the present invention, a magnetic recording/reproducing apparatus is for reproducing data from a magnetic recording medium which has a servo area having a preamble area where servo data for clock synchronization is recorded; and a data area where user data can be written into via a magnetic head. The magnetic recording/reproducing apparatus includes an analog-digital converting unit that converts an analog preamble reproduction signal into a digital preamble reproduction signal by taking sampled values at six points in one cycle of the analog preamble reproduction signal reproduced from the preamble area at a generation timing of a servo reference clock; a phase adjusting unit that detects a phase difference of the analog preamble reproduction signal based on the sampled values taken at six points by the analog-digital converting unit, and adjusts a phase of the servo reference clock based on the detected phase difference to adjust a sampling timing of the analog-digital converting unit; and a gain controlling unit that detects an amplitude of the analog preamble reproduction signal based on the sampled values taken at six points by the analog-digital converting unit, and controls a gain of the analog preamble reproduction signal based on the detected amplitude.

According to still another aspect of the present invention, a magnetic recording/reproducing apparatus includes an analog-digital converting unit that converts an analog preamble reproduction signal into a digital preamble reproduction signal by taking sampled values at six points in one cycle of the analog preamble reproduction signal reproduced from the preamble area at a generation timing of a servo reference clock; a phase adjusting unit that adjusts a sampling timing of the analog-digital converting unit by detecting a phase difference of the preamble reproduction signal based on the sampled values taken at six points by the analog-digital converting unit and adjusting a phase of the servo reference clock based on the detected phase difference; and a gain controlling unit that controls a gain of the preamble reproduction signal based on an amplitude of the preamble reproduction signal by detecting the amplitude of the preamble reproduction signal based on the sampled values taken at six points by the analog-digital converting unit.

According to still another aspect of the present invention, a stamper for manufacturing a magnetic recording medium, includes an area with a depression and a protrusion corresponding to a magnetic portion which represents servo data for clock synchronization and a non-magnetic portion of a preamble area of the magnetic recording medium, and an occupancy of the depression is different from an occupancy of the protrusion.

### BRIEF DESCRIPTION OF THE DRAWINGS

FIG. 1 is a schematic diagram of a structure of a magnetic recording medium according to a first embodiment;

FIG. 2 is an enlarged view of a data area 100 and a servo area 110 of the magnetic recording medium according to the first embodiment;

FIGS. 3A to 3G are sectional views of a manufacturing process of the magnetic recording medium according to the first embodiment;

FIGS. 4A and 4B are graphs of a reproduction signal after processing of differentiation/equalization by the magnetic recording medium according to the first embodiment;

FIG. 5 is a block diagram of a structure of a preamble area reproducing circuit of a magnetic recording/reproducing apparatus according to the first embodiment;

FIG. 6 is a diagram of a principle of amplitude detection of a preamble reproduction signal;

FIG. 7 is a diagram of a principle of phase difference detection in the PLL process;

FIG. 8 is a graph of sample points of an in-phase preamble reproduction signal;

FIG. 9 is a schematic diagram of a structure of a servo area in a magnetic recording medium according to a second embodiment;

FIG. 10 is a schematic diagram of a structure of a preamble area 1101 in a servo area of a magnetic recording medium according to a third embodiment;

FIG. 11 is a block diagram of a structure of a preamble area reproducing circuit in a magnetic recording/reproducing apparatus according to the third embodiment;

FIG. 12 is a diagram of a principle of amplitude detection of the preamble reproduction signal;

FIG. 13 is a diagram of a principle of phase difference detection in a PLL process in the preamble area reproducing circuit 1100 according to the third embodiment;

FIG. 14 is a diagram of sample points of an in-phase preamble reproduction signal;

FIG. 15 is a block diagram of a structure of a preamble area reproducing circuit 1500 according to a fourth embodiment;

FIG. 16 is a block diagram of a structure of a phase amplitude detector 1507; and

FIGS. 17A and 17B are graphs of a reproduction signal after the processing of differentiation/equalization by the conventional magnetic recording medium where the occupancy of the magnetic portion in the preamble area is 50%.

### DETAILED DESCRIPTION OF THE PREFERRED EMBODIMENTS

In the following, exemplary embodiments of a magnetic recording medium, a magnetic recording/reproducing apparatus, and a stamper for manufacturing the magnetic recording medium according to the present invention are described in detail with reference to the accompanying drawings.

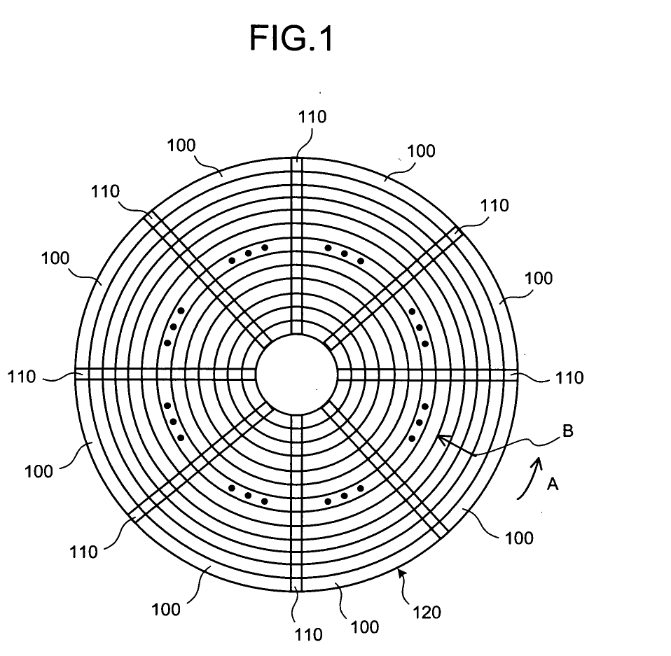

FIG. 1 is a schematic diagram of a structure of the magnetic recording medium according to a first embodiment of the present invention. FIG. 1 shows the magnetic recording medium as viewed from above. As shown in FIG. 1, the magnetic recording medium is provided with plural tracks 120 concentrically arranged. Each track is divided into plural data areas 100 by plural servo areas 110 which are formed approximately radially.

The data area 100 is a area where user data can be written into via a magnetic head of a magnetic recording/reproducing apparatus. The servo area 110 is an area where servo data is previously recorded for positioning of the magnetic head of the magnetic recording/reproducing apparatus on the magnetic recording medium.

Here, a track direction of the magnetic recording medium means a direction of arrangement of the sectors in each track along which a sector address number increases/decreases, and indicated by an arrow A in FIG. 1 for the magnetic recording medium of the first embodiment.

Respective data areas are sequentially addressed as physical sectors 0 to N along the track direction. In FIG. 1, eight sectors are shown provided that N=7 for the convenience of description. However, in an actual magnetic recording medium, N>100.

A radial direction of the magnetic recording medium is a direction along the radius of the magnetic recording medium, and corresponds to the width direction of the track shown by an arrow B in FIG. 1 in the magnetic recording medium of the first embodiment.

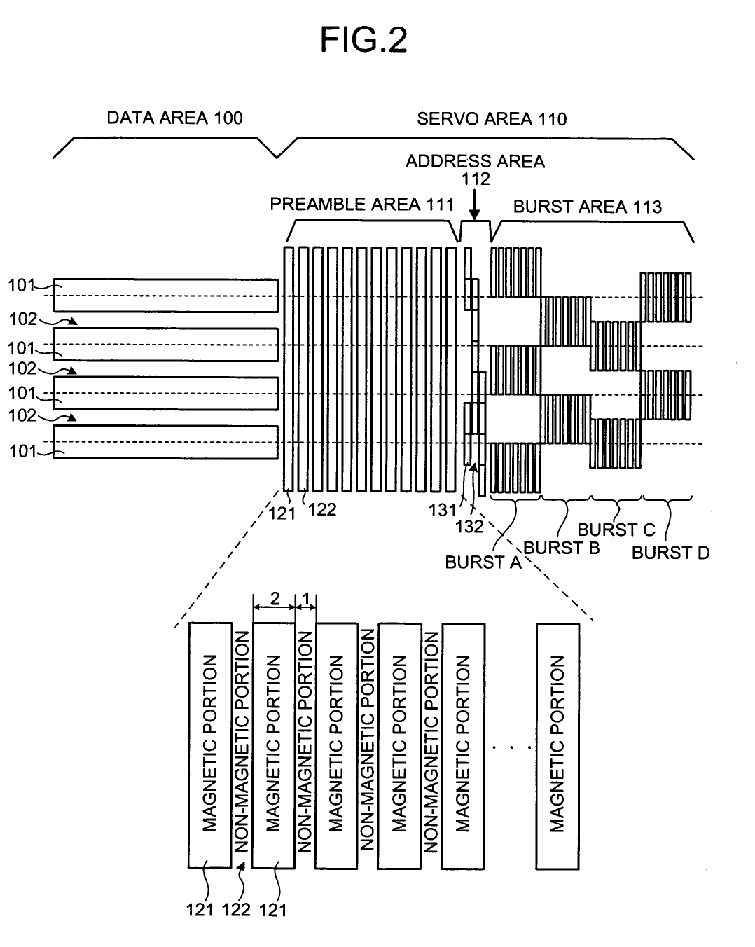

FIG. 2 is an enlarged view of the data area 100 and the servo area 110 of the magnetic recording medium according to the first embodiment.

As shown in FIG. 2, the magnetic recording medium of the first embodiment is formed so that the data areas 100 are arranged-in parallel along the track direction of each servo area 110.

In the data area 100, plural tracks having a magnetic belt 101 where user data can be written into via the magnetic head are arranged, and a non-magnetic belt 102, where the user data cannot be written into, is provided between adjacent tracks. Thus, the magnetic recording medium according to the first embodiment is a discrete track-type recording medium where the magnetic belts 101 are physically separated by the non-magnetic belts 102.

The servo area 110 has magnetic portions 121 and 131 and non-magnetic portions 122 and 132—formed by full-imprinting by the stamper at the manufacturing of the magnetic recording medium. Here, the non-magnetic portions 122 and 132 are formed as a filled non-magnetic portion. When the servo data in the servo area 110 is reproduced by the magnetic head of the magnetic recording/reproducing apparatus, the data in the magnetic portions 121 and 131 are reproduced as a binary value “1” whereas the data in the non-magnetic portions 122 and 132 are reproduced as a binary value “0.”

As shown in FIG. 2, the servo area 110 is formed from a preamble area 111, an address area 112, and a burst area 113.

Here, in the magnetic recording medium of the first embodiment, perpendicular magnetic recording is adopted where the magnetic film in the magnetic portion and the magnetic belt is magnetized in a perpendicular direction (direction of thickness of the medium). In the magnetic recording medium of the first embodiment, the non-magnetic belt 102 and the non-magnetic portions 122 and 132 are formed as the filled non-magnetic portion, alternatively the non-magnetic belt 102 and the non-magnetic portions 122 and 132 may be formed as gaps.

The preamble area 111 is an area where the servo data for the clock synchronization is recorded, in which the magnetic portion 121 corresponding to a code “1” of the servo data and the non-magnetic portion 122 corresponding to a code “0” of the servo data are formed. The data in the preamble area 111 is read out by the magnetic head prior to the data in the address area 112 and the burst area 113, and utilized for the PLL process for the clock synchronization of the reproduction signal of the servo data with respect to the time lag caused by the shift of the rotational axis of the magnetic recording medium and for the AGC process for the maintenance of appropriate amplitude of the reproduction signal.

In the preamble area 111 the plural magnetic portions 121 are arranged as to linearly extend along a direction of track width (direction indicated by the arrow B of FIG. 1, vertical direction of FIG. 2) in the track direction so that the magnetic head of the magnetic recording/reproducing apparatus can obtain a similar reproduction signal from the servo data irrespective of the position of the magnetic head relative to the track position. The plural magnetic portions 121 are recorded in a preamble recording pattern where the plural magnetic portions 121 are arranged along the track direction with the non-magnetic portions 122 therebetween.

In the address area 112, the servo data such as a code called a servo mark which indicates the beginning of the servo area 110, sector information, cylinder information, is recorded according to Manchester encoding which represents the binary value “0” by a code “01” and the binary value “1” by a code “10.” In the address area 112, the magnetic portion 131 corresponding to the code “1” and the non-magnetic portion 132 corresponding to the code “0” of the servo data in the Manchester encoding are formed. The address area 112 records the servo data in a gray code so that the magnetic head can read the data even while seeking.

The burst area 113 is an area where servo data is recorded to seek information on the positional deviation, i.e., the relative position of the magnetic head with respect to the track center. The magnetic portion 121 and the non-magnetic portion 122 are formed in correspondence with the codes (“1” and “0”) of the servo data.

As shown in FIG. 2, the burst area 113 is formed from four sections with different arrangement phases, i.e., a burst A, a burst B, a burst C, and a burst D. Each of the bursts A-D includes magnetic portions with non-magnetic portions interposed therebetween. The bursts A and B are symmetrically arranged with respect to the track center, whereas the bursts C and D are arranged in even-numbered tracks and odd-numbered tracks, respectively, i.e., alternately with respect to the track boundaries. When the magnetic head traces the burst area 113, burst reproduction signals reproduced from the bursts C and D have phases 90 degrees off from the phase of burst reproduction signals reproduced from the bursts A and B.

In the magnetic recording medium of the discrete track type according to the first embodiment, the ratio of the width of the magnetic belt 101 and the non-magnetic belt 102 of the data area 100 in the radius direction of the magnetic recording medium is 2:1, and the occupancy of the magnetic portion in the data area 100 is approximately 66.7%. Though the ratio of the width of the magnetic belt 101 to the non-magnetic belt 102 in the data area 100 in the first embodiment is 2:1, the ratio thereof is not limited thereto. For example, the ratio of the width of the magnetic belt 101 to the non-magnetic belt 102 in the radius direction of the magnetic recording medium may be 5:2 (in this case occupancy of the magnetic portion is approximately 71.4%), and preferably in the range of 2:1 to 3:2. Here, some error may be generated as manufacturing error and the ratio may not be strictly as mentioned above.

In the address area 112 of the servo area 110, the servo data is recorded in the Manchester encoding as described above to form the magnetic portion 131 and the non-magnetic portion 132, the occupancy of the magnetic portion in the track direction is 50%. In the burst area 113 of the servo area 110, the occupancy of the magnetic portion in the track direction is 75% and the reverse burst with a negative marking (non-magnetic marking) is employed.

In the preamble area 111 of the servo area 110, the ratio of the magnetic portion 121 representing the code “1” to the non-magnetic portion 122 representing the code “0” is 2:1, hence the occupancy of the magnetic portion 121 is different from the occupancy of the non-magnetic portion 122, and the occupancy in the track direction is 66.7%.

In the conventional magnetic recording medium, the servo area is formed so that the Manchester encoding is employed for the recording of the servo data both in the address area and the preamble area for the formation of the magnetic portion and the non-magnetic portion. Hence, the occupancys of the magnetic portion to the non-magnetic portion in these areas are the same and the occupancy in the track direction is both 50%.

The function of the preamble area, however, is basically the generation of reference signals for the PLL process for the synchronization of a reproduction clock of the magnetic recording/reproducing apparatus to the rotation speed of the magnetic recording medium for the precise reproduction of the address information or the like recorded in the track or the sector regardless of the fluctuation in the rotation or the like at the time of reproduction of data from the magnetic recording medium, and the execution of the AGC process for the adjustment of the level of reproduction amplitude which corresponds with the data “1” or “0” in the servo data. As far as the execution of the PLL process and the ACG process is properly realized, the occupancy of the magnetic portion in the track direction does not need to be 50%.

Hence, in the magnetic recording medium of the present invention, the occupancy of the magnetic portion in the track direction in the preamble area 111 is made equal to the occupancy of the magnetic portion in the radius direction of the magnetic recording medium in the data area 100. Thus, the reliable recording of the preamble signals is allowed on the entire surface of the magnetic recording medium (i.e., in all tracks/sectors). As a result, the yield of the magnetic recording medium can be significantly improved.

Here, the reliable recording of the preamble signals is allowed when the difference in the occupancy of the magnetic portion in the preamble area 111 and the data area 100 is within a range of approximately 10%. For example, if the ratio of the width of the magnetic portion to the width of the non-magnetic portion is 5:2 in the preamble area 111, in other words, if the occupancy of the magnetic portion is approximately 71.4% in the preamble area 111, the difference in the occupancy of the magnetic portion with the data area 100 is still approximately 4.7%, and even if the ratio of the width of the magnetic portion to the width of the non-magnetic portion is 3:2, in other words, the occupancy of the magnetic portion is 60%, the difference in the occupancy of the magnetic portion is still approximately 6.7%.

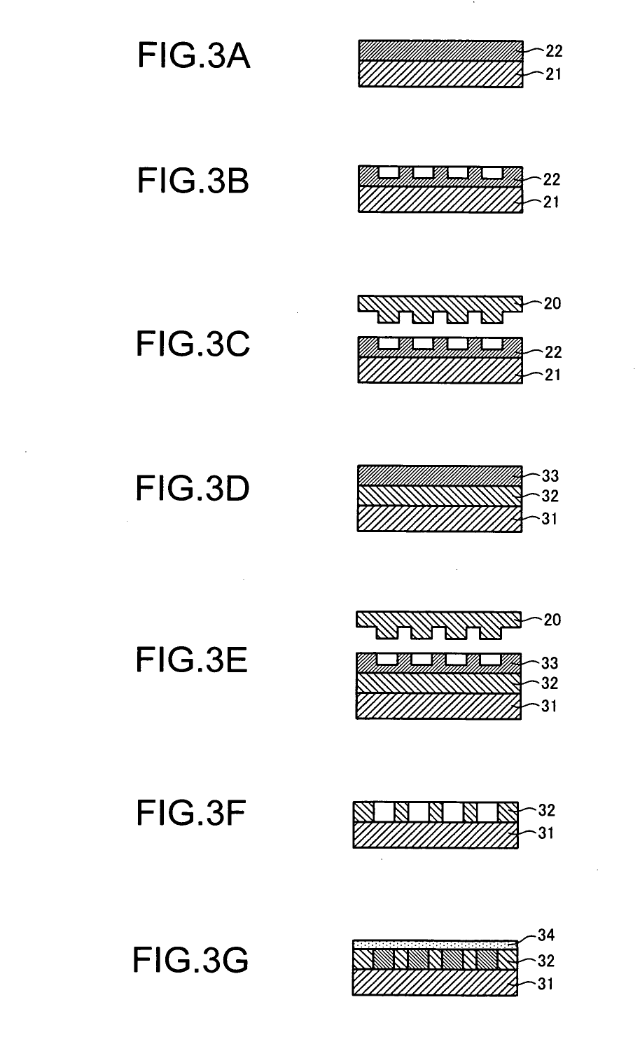

Next, a method of manufacturing the magnetic recording medium according to the first embodiment of the present invention is described. FIGS. 3A to 3G are sectional views of the magnetic recording medium in manufacturing process according to the first embodiment. As shown in FIGS. 3A to 3C, first, the imprint stamper is formed.

When the magnetic recording medium according to the first embodiment is formed by the imprint lithography, the imprint stamper is fabricated so that depressions corresponding to the magnetic portions of the magnetic recording medium and protrusions corresponding to the non-magnetic portions of the magnetic recording medium are formed thereon.

First, as shown in FIG. 3A, an electron beam resist 22 is coated on a master disk 21. The master disk 21 is preferably made from silicon or glass. After a direct drawing on the electron beam resist 22 with the electron beam, the plate is developed to form a pattern of depressions/protrusions on the electron beam resist 22 as shown in FIG. 3B. Then, the electroforming is performed on the master disk 21, on which the pattern of depressions/protrusions of the electron beam resist 22 is generated, to form a metallic disk and strip off the metallic disk, which serves an imprint stamper 20 as shown in FIG. 3C. The stamper is formed preferably from a material such as Ni, though not limited thereto.

On the surface of the imprint stamper 20, a pattern of protrusions reverse to the pattern of magnetic portion on the magnetic recording medium of FIG. 2 is formed.

Here, after the process shown in FIG. 3B, the formed resist pattern may be employed as a mask for the etching of the master disk 21, and the pattern of depressions/protrusions of the resist may be imprinted to the master disk 21, for the manufacture of the imprint stamper.

Subsequently, the magnetic recording medium is formed by the imprint lithography. As shown in FIG. 3D, a magnetic film 32 is formed from a suitable material for the perpendicular recording and applied on a substrate 31. Here, a soft magnetic underlying film and a strong magnetic recording film are preferably prepared for the formation of the magnetic film 32 as a perpendicular two-layered film medium. A resist 33 for imprinting is coated on the magnetic film 32.

Then, as shown in FIG. 3E, the stamper 20 is placed opposite to the resist 33 on the substrate 31 to be pressed on to the resist 33 to imprint the pattern of protrusions on the stamper 20 to the surface of the resist 33. Thereafter, the stamper 20 is removed from the resist 33. The resist 33 with the pattern of depressions/protrusions is employed as a mask for the etching of the magnetic film 32, whereby the magnetic film 32 as shown in FIG. 3F is formed. Thus, the pattern of the magnetic portion as shown in FIG. 2 is formed.

Thereafter, a carbon protective film 34 is applied on the magnetic film 32 as shown in FIG. 3G, followed by the application of the lubricant to finish the manufacturing of the magnetic recording medium.

When the ratio of an area occupied by the protrusions is small as in the imprint stamper 20 described above, the difference of resist residue thickness after the imprinting can be reduced. When the resist is used as a mask for the etching of the magnetic film, a substantially uniform thickness of the magnetic pattern can be realized.

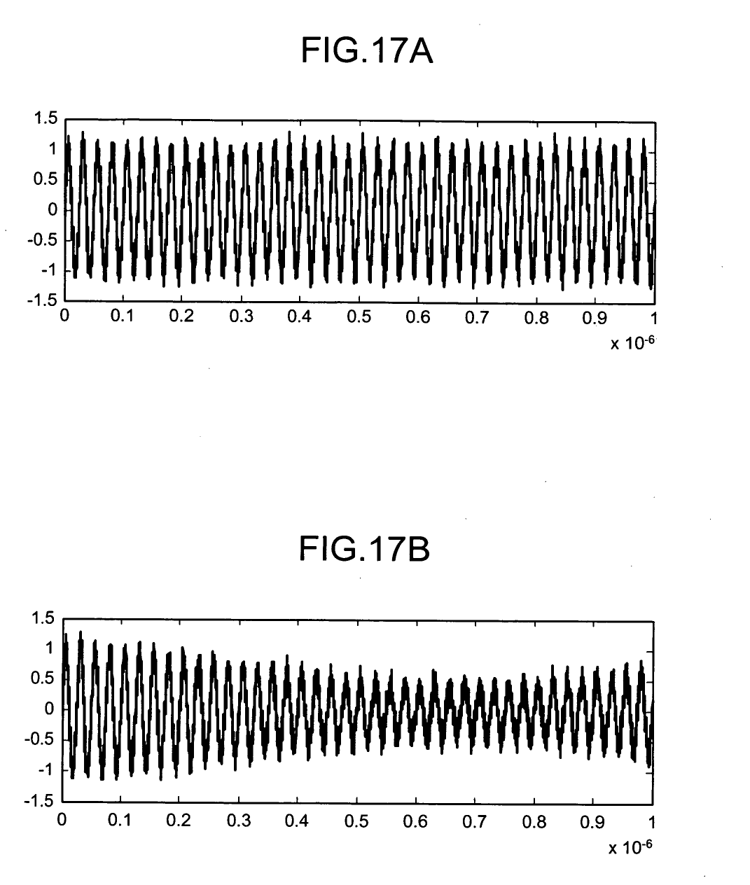

FIGS. 17A and B are graphs of a reproduction signal after differentiation/equalization processing by the conventional magnetic recording medium having the preamble area with the magnetic portion occupying 50% of the area. FIG. 17A shows an example of the reproduction signal obtained from a portion with a favorable imprinting result and FIG. 17B is another example of the reproduction signal obtained from a portion with an error in imprinting.

In the conventional magnetic recording medium, though the data is recorded in the Manchester encoding with the occupancy of magnetic portion of 50% in the preamble area and the address area, the occupancy of the magnetic portion is higher in the data area and the burst area. In other words, the area ratio occupied by the protrusions in the corresponding part of the stamper is significantly different in the preamble area and address area from the data area and the burst area. As a result, the stress concentration to the stamper tends to occur in the vicinity of the address area and the preamble area to cause defective imprinting. For example, the formed magnetic pattern may not follow the specification around the central portion of the Manchester code, or the stable formation of the burst area may not be realized.

To eliminate such inconvenience, the manufacturing condition of the magnetic recording medium is adjusted through trial and error, whereby servo dysfunction can be prevented in nearly the entire area. However, in some areas, the stability in the imprinting of the magnetic pattern is not satisfactory in view of the quality of the entire magnetic recording medium. In particular, the amplitude in the preamble area lowers as shown in FIG. 17B.

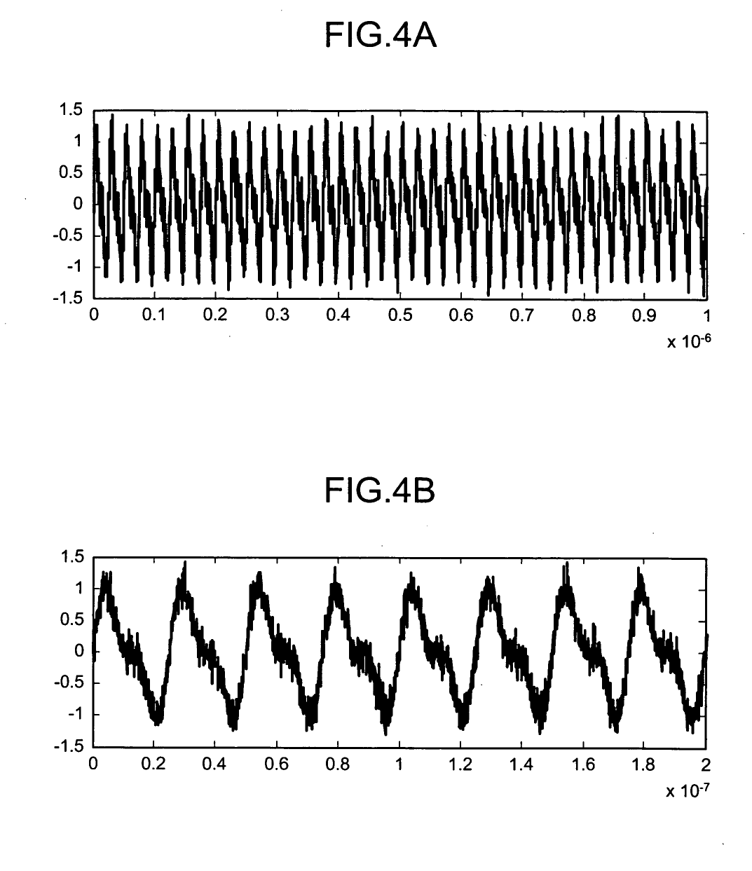

FIGS. 4A and B are graphs of the reproduction signals after differentiation/equalization processing by the magnetic recording medium according to the first embodiment. FIG. 4A represents an entire reproduction signal whereas FIG. 4B represents a portion of FIG. 4A enlarged along the temporal axis.

Here, the differentiation/equalization processing is a process to convert an analog reproduction signal obtained from the preamble area 111 to an equalization signal corresponding to a longitudinal recording reproduction signal. Since the data is recorded according to the perpendicular magnetic recording technique in the magnetic portion of the magnetic recording medium, analog filtering is performed on the analog reproduction signal with a low-pass filter (LPF) or the like. The differentiation/equalization processing is realized with an equalizer which is described later.

Since the servo data is recorded according to the Manchester encoding in the address area 112, the occupancy of the magnetic portion in the address area 112 is 50% which is relatively smaller compared with other areas. However, the area occupied by the address area 112 on the magnetic recording medium is extremely small. Hence, the influence thereof is insignificant and an error in address information reading does not occur. Thus, the reproduction signal obtained from the preamble area 111 according to the first embodiment has substantially the same amplitude over the area as shown in FIG. 4A.

The ratio of the width of the magnetic portion to the width of the non-magnetic portion in the preamble area 111 is approximately 2:1 in the first embodiment. Hence, the distortion of the reproduction signal obtained from the preamble area 111 is more notable compared with that of the reproduction signal obtained from the preamble area 111 where the ratio of the width of the magnetic portion to the width of the non-magnetic portion is approximately 1:1 as shown in FIG. 13. The influence of such distortion is described below.

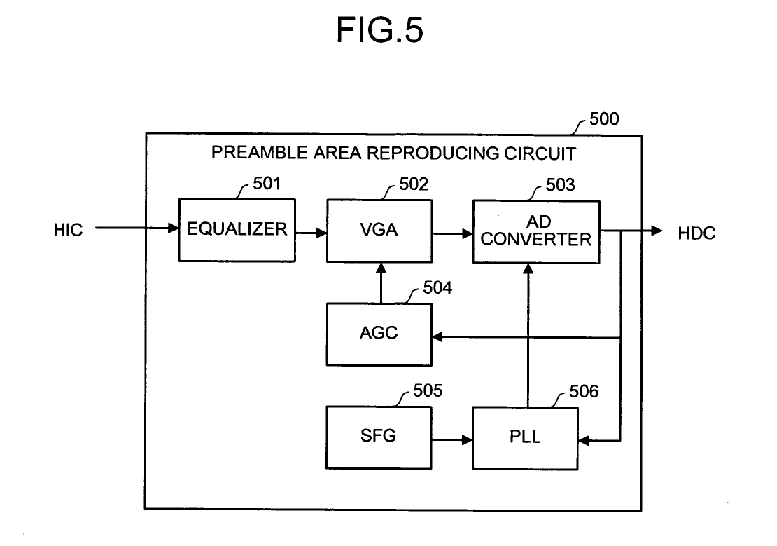

The magnetic head detects the leakage field of the magnetic pattern on the disk (magnetic recording medium) right below the head as an electric signal to deliver the same to a reproduction signal processing integrated circuit (IC) (channel) via a head amplifier integrated circuit (HIC). The reproduction signal processing IC performs a reproduction processing of the signal read by the magnetic head from respective areas such as the preamble area 111, the address area 112, and the burst area 113. A preamble area reproducing circuit according to the first embodiment, which reproduces the signal from the preamble area 111 is described. FIG. 5 is a block diagram of a structure of the preamble area reproducing circuit of the magnetic recording/reproducing apparatus according to the first embodiment.

The preamble area reproducing circuit 500, as shown in FIG. 5, includes an equalizer 501, a variable gain amplifier (VGA) 502, an analog-digital (AD) converter 503, an auto gain controller (AGC) 504, a servo frequency generator (SFG) 505, and a phase lock loop (PLL) 506.

Since the data is recorded according to the perpendicular magnetic recording technique in the magnetic portion of the magnetic recording medium according to the first embodiment, the equalizer 501 performs analog filtering on the analog reproduction signal obtained from the preamble area 111 by an LPF or the like to convert the same into the equalization signal corresponding to the longitudinal recording reproduction signal.

The VGA 502 is a circuit with a variable gain for amplifying the longitudinal equalization signal supplied from the equalizer 501. The amplitude of the longitudinal equalization signal is adjusted to be constant by the VGA 502.

The AD converter 503 converts the analog longitudinal equalization signal amplified by the VGA 502 into a digital signal at a sampling timing following a reproduction clock generated by the PLL 506 described later. The AD converter 503 extracts samples of the analog longitudinal equalization signal at four points in every cycle.

The AGC 504 detects the amplitude of the preamble reproduction signal from the sampled values for one cycle of the preamble reproduction signal, which is the reproduction signal from the preamble area 111, and controls the gain of the VGA 502 based on the detected amplitude. The detailed process of amplitude detection is described later. The SFG 505 generates a servo reference clock.

The PLL 506 detects the amplitude of the preamble reproduction signal from the sampled values at four points of one cycle of the preamble reproduction signal, which is a reproduction signal of the preamble area 111, and adjusts the phase of the servo reference clock generated by the SFG 505 based on the detected amplitude. The PLL 506 further generates a reproduction clock whose phase and N-times cycle match with those of the preamble reproduction signal detected by the AD converter 503, to realize an appropriate sampling timing for the AD conversion by the AD converter 503. The detail of phase difference detection is described later.

In the first embodiment, the cycle of the magnetic portion and the non-magnetic portion of the servo area 110 is four times that of the servo reference clock (i.e., 4 T width), in other words, the number (N) of sampling in one cycle of the preamble reproduction signal is 4 (N=4).

In the following the processes performed by the AGC 504 and the PLL 506 according to the first embodiment are described, in which the process when the preamble area has the magnetic portion occupying 50% of the area as in the conventional magnetic recording medium and the process when the same is 66.7% as in the first embodiment are described for comparison.

First, the process when the preamble area 111 has the magnetic portion occupying 50% of the area as in the conventional magnetic recording medium is described.

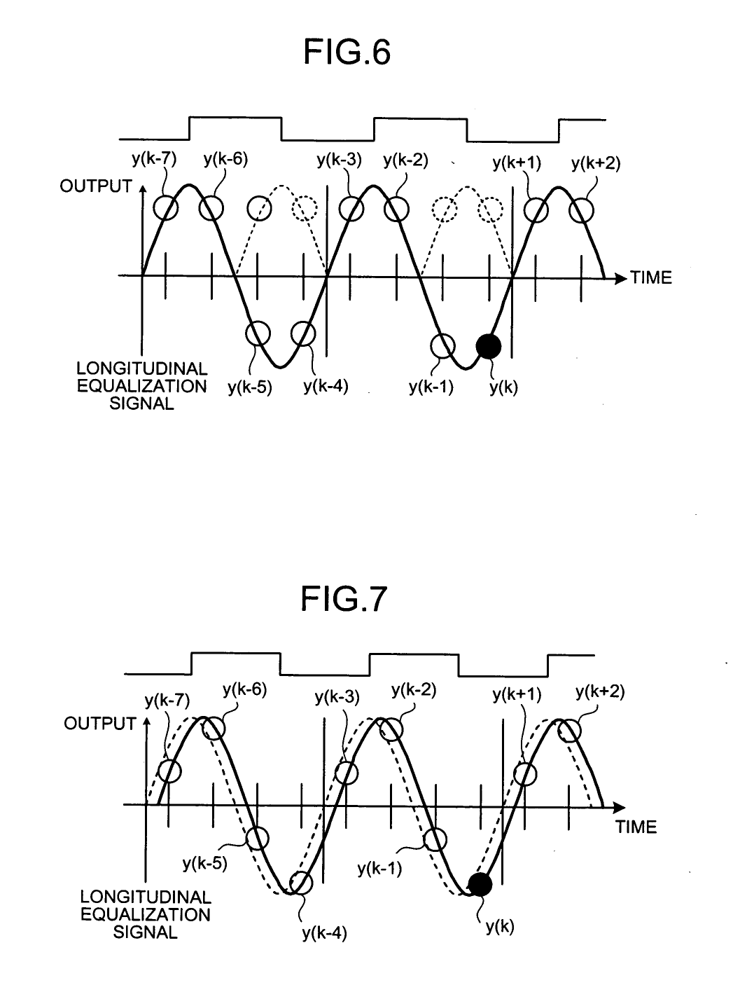

The AGC 504 needs to detect the amplitude of the preamble reproduction signal at the current timing in order to control the gain of the VGA 502. The process of amplitude detection is first described. FIG. 6 is a diagram shown to describe a principle of the detection of the amplitude of the preamble reproduction signal, and shows in particular a condition where the amplitude of the preamble reproduction signal as the longitudinal equalization signal is sampled at four points in one cycle and the phase synchronization by the PLL is nearly finished. The phase synchronization by the PLL is described later.

In FIG. 6, a solid line represents the preamble reproduction signal after the equalization, and a white circle represents each sampled value in four-point sampling. A sampled value y(k) at a current time k is represented by a black circle.

When the number of sampling N for each cycle of the preamble reproduction signal is four as in the first embodiment, the sampled values of each cycle of the preamble reproduction signal can be always represented as y(k−3), y(k−2), y(k−1), and y(k). When the sampling is performed k times at the sampling timing as shown in FIG. 6, an inner product of the sampled values and the factors [1,1,−1,−1], respectively, results in the sum of the absolute values of the equalization signal at four points indicated by dotted line in FIG. 6. Thus, an inner product G(k) which is proportional to the amplitude can be obtained. If a loop delay is added to the factor [1,1,−1,−1] to be, for example, [1,−1,−1,1], [−1,−1,1,1], [−1,1,1,−1], [1,1,−1,−1], and different factor is employed for each sampling timing, the inner product always attains the value of the sum of the absolute values at four points of the longitudinal equalization signal. For example, if [y(k−2),y(k−1),y(k),y(k+1)], [y(k−1),y(k),y(k+1),y(k+2)], [y(k),y(k+1),y(k+2),y(k+3)], [y(k+1),y(k+2),y(k+3),y(k+4)] are multiplied respectively by factors [1,−1,−1,1], [−1,−1,1,1], [−1,1,1,−1], [1,1,−1,−1], the result is always the sum of the absolute values at four points of the longitudinal equalization signal. The AGC 504 sequentially compares the resulting sum and a reference value to change the gain of the VGA 502 according to the result of comparison, whereby the amplitude of the preamble signal can be adjusted to be a predetermined value.

Next, the PLL process by the PLL 506 is described. To realize the PLL process, the phase shift (phase difference) of the longitudinal equalization signal needs to be detected for the adjustment of the sampling timing. FIG. 7 is a diagram shown to describe a principle of the phase difference detection in the PLL process. A dotted line in FIG. 7 represents the longitudinal equalization signal perfectly in phase whereas a solid line represents the longitudinal equalization signal with a slight phase delay.

As can be seen from FIG. 7, when the phase difference is zero and the signal is perfectly in phase (as shown by the dotted line), the relation represented by Expression (1) holds for each sampled value.
y(k−3)=y(k−2),y(k−1)=y(k) (1)

In other words, when an inner product H(k) is calculated with the factor [1,−1,−1,1] for the four points in a cycle of the preamble reproduction signal [y(k−3),y(k−2),y(k−1),y(k)], the result is H(k)=0. Further, when a loop delay is added to the factors similarly to the AGC process, H(k)=0 holds for each sampled value. In other words, when [y(k−2),y(k−1),y(k),y(k+1)], [y(k−1),y(k),y(k+1),y(k+2)], [y(k),y(k+1),y(k+2),y(k+3)], [y(k+1),y(k+2),y(k+3),y(k+4)] are multiplied with factors [−1,−1,1,1], [−1,1,1,−1], [1,1,−1,−1], and [1,−1,−1,1], respectively, H(k)=0 is obtained for each sampled value.

On the other hand, when there is a slight phase delay as shown in FIG. 7 (by the solid line), the relation represented by Expression (2) holds for each sampled value.
y(k−3)<y(k−2), −y(k−1)<−y(k) (2)

Then, when the factor for the four points in the cycle of the preamble reproduction signal is set as [1,−1,−1,1], the inner product H(k) is smaller than zero (H(k)<0), whereby the phase delay can be determined based on the value of H(k).

When the k point changes sequentially, the inner product H(k) of the sampled values and the loop-delayed factors is always constant. When the phase is ahead, the relation represented by Expression (3) holds for each sampled value.
y(k−3)>y(k−2), −y(k−1)>−y(k) (3)

Hence, when the factors for four points in the cycle of the preamble reproduction signal is set as [1,−1,−1,1], the inner product H(k) is always larger than zero (H(k)>0), and the phase is determined to be ahead.

Thus, the PLL 506 detects the phase difference based on the inner product H(k) and adjusts the delay of the servo reference clock utilizing a voltage controlled oscillator (VCO) inside the PLL 506, thereby realizing the reproduction signal clock synchronization.

The detection process described above is a simplified process based on the phase/amplitude separation for the orthogonal detection and the phase difference (phase shift) is assumed to be small. Next, the reason why the above described process is applicable when the phase difference is small is described.

Ideally, an equalization signal with an amplitude G0 and a phase difference H0 can be represented by the following Expression (4).
y(k)=G0*sin(2πk/N+H0+π/N)
=G0*sin(2k+1)π/N+H0), N=4,k=0,1,2,3 (4)
G0: Amplitude, H0: PhaseDifference

The sampled values y(0), y(1), y(2), and y(3) at four points in every cycle can be represented by following Expressions (5) to (8) based on Expression (4).
y(0)=G0*sin(π/4+H0) (5)
y(1)=G0*sin(3π/4+H0) (6)
y(2)=G0*sin(5π/4+H0) (7)
y(3)=G0*sin(7π/4+H0) (8)

In addition, if hₖ=(2k+1)n/N in Expression (4), Expression (4) is transformed into the following Expression (9).

$$\begin{matrix}y ( k ) = G 0 * sin ( {h}_{k} + H 0 ) \\ = G 0 * \{ sin ( {h}_{k} ) cos ( H 0 ) + cos ( {h}_{k} ) sin ( H 0 ) \}\end{matrix} \\ Here , {h}_{k} = ( 2 k + 1 ) π / N \qquad ( 9 )$$

Here, if the factor of the orthogonal detection represented in Expressions (11) and (12), i.e., A(k)=sin(hₖ) is set as the factor [1,1,−1,−1] to find the inner product G(k) in proportion to the amplitude as described above, and multiplied by the sampled value y(k), the following Expression (10) is obtained.
A(k)y(k)=G0*{sin²(hₖ)cos(H0)+sin(hₖ)cos(hₖ)sin(H0)} (10)
A(k)=sin(hₖ) (11)
A(k)=[A(0),A(1),A(2),A(3)]=\sqrt{2}/2*[1,1,−1,−1] (12)

If the value A(k)y(k) is integrated with 4 T for one cycle, the integrated value G(k) is represented by Expression (13).

$$\begin{matrix}G ( k ) = {\int }_{0}^{4 T} A ( k ) y ( k ) \\ = {\int }_{0}^{4 T} G 0 * \{ {sin}^{2} ( {h}_{k} ) cos ( H 0 ) + sin ( {h}_{k} ) cos ( {h}_{k} ) sin ( H 0 ) \} ⅆ K + \\ G 0 * sin ( H 0 ) {\int }_{0}^{4 T} sin ( {h}_{k} ) cos ( {h}_{k} ) ⅆ k \\ = G 0 * cos ( H 0 ) {\int }_{0}^{4 T} {sin}^{2} ( {h}_{k} ) ⅆ k\end{matrix} \qquad ( 13 )$$

As can be seen from Expression (13), the integrated value for 4T/cycle of sin(hₖ)cos(hₖ) is zero. Hence, the integrated value G(k) is eventually only a term of integrated value sin²(hₖ). Further, the integrated value G(k) for 4 T/cycle is equivalent to the inner product of sampled values y(k) of four points and the factors A(k) (here, k=0,1,2,3). Further, the integrated value G(k) for 4 T/cycle of A(k)y(k) is only a term of integrated value sin²(hₖ) as shown by Expression (13), and the factor A(k) is represented by Expression (12) which is equivalent to Expression (11), whereby the integrated value G(k) for 4 T/cycle of A(k)y(k) is calculated following Expression (14).

$$\begin{matrix}G ( k ) = {\sum }_{i = 0}^{3} A ( i ) y ( i ) \\ = G 0 * cos ( H 0 ) * \{ {sin}^{2} ( {h}_{0} ) + {sin}^{2} ( {h}_{1} ) + {sin}^{2} ( {h}_{2} ) + {sin}^{2} ( {h}_{3} ) \} \\ = G 0 * cos ( H 0 ) * \{ {( \sqrt{2} / 2 )}^{2} * ( 1 + 1 + 1 + 1 ) \} \\ = 2 * G 0 * cos ( H 0 )\end{matrix} \qquad ( 14 )$$

In Expression (13), it is assumed that N=4. If Expression (13) is generalized for N, the integrated value G(k) for 4 T/cycle of A(k)y(k) can be represented by Expression (15).

$$\begin{matrix}G ( k ) = {\sum }_{i = 0}^{N} A ( i ) y ( i ) \\ = G 0 * cos ( H 0 ) * \{ {sin}^{2} ( {h}_{0} ) + {sin}^{2} ( {h}_{1} ) + {sin}^{2} ( {h}_{2} ) + \\ {sin}^{2} ( {h}_{3} ) + … + {sin}^{2} ( {h}_{N - 1} ) \} \\ = G 0 * cos ( H 0 ) * \{ {( \sqrt{2} / 2 )}^{2} * ( 1 + 1 + 1 + 1 + … + 1 ) \} \\ = ( N / 2 ) * G 0 * cos ( H 0 )\end{matrix} \qquad ( 15 )$$

Further, when the factor of the orthogonal detection B(k)=cos(hₖ) shown in Expressions (17) and (18) is set as the factor [1,−1,−1,1] to find the inner product H(k) described above similarly to Expression (10), and multiplied by the sampled values y(k), the following Expression (16) can be obtained.
B(k)y(k)=G0*cos(hₖ)sin(hₖ)cos(H0)+cos²(hₖ)sin(H0)} (16)
B(k)=cos(hₖ) (17)
B(k)=[B(0),B(1),B(2),B(3)]=\sqrt{2}/2*[1,−1,−1,1] (18)

If the B(k)y(k) is integrated by 4 T/cycle, the integrated value H(k) can be represented by the following Expression (19).

$$\begin{matrix}H ( k ) = {\int }_{0}^{4 T} B ( k ) y ( k ) \\ = {\int }_{0}^{4 T} G 0 * \{ cos ( {h}_{k} ) sin ( {h}_{k} ) cos ( H 0 ) + {cos}^{2} ( {h}_{k} ) sin ( H 0 ) \} ⅆ k \\ = G 0 * cos ( H 0 ) {\int }_{0}^{4 T} cos ( {h}_{k} ) sin ( {h}_{k} ) ⅆ k + \\ G 0 * sin ( H 0 ) {\int }_{0}^{4 T} {cos}^{2} ( {h}_{k} ) ⅆ k \\ = G 0 * sin ( H 0 ) {\int }_{0}^{4 T} {cos}^{2} ( {h}_{k} ) ⅆ k\end{matrix} \qquad ( 19 )$$

As shown in Expression (19), the integrated value for 4 T/cycle of sin(hₖ)cos(hₖ) is zero. Hence, the integrated value H(k) eventually is only a term of an integrated value of cos²(hₖ). Further, the integrated value H(k) for 4 T/cycle is equivalent to the inner product of the sampled values y(k) at four points and the factors B(k) (here, k=0,1,2,3). Still further, the integrated value H(k) for 4 T/cycle for B(k)y(k) is only a term of the integrated value cos²(hₖ) as in Expression (19), and the factor B(k) can be represented by Expression (18) which is equivalent to Expression (17). Hence, the integrated value H(k) for 4 T/cycle of B(k)y(k) can be calculated as shown by a Expression (20).

$$\begin{matrix}H ( k ) = {\sum }_{i = 0}^{3} B ( i ) y ( i ) \\ = G 0 * sin ( H 0 ) * \{ {cos}^{2} ( {h}_{0} ) + {cos}^{2} ( {h}_{1} ) + {cos}^{2} ( {h}_{2} ) + {cos}^{2} ( {h}_{3} ) \} \\ = G 0 * sin ( H 0 ) * \{ {( \sqrt{2} / 2 )}^{2} * ( 1 + 1 + 1 + 1 ) \} \\ = 2 * G 0 * sin ( H 0 )\end{matrix} \qquad ( 20 )$$

In Expression (20), it is assumed that N=4. When Expression (20) is generalized for N, the integrated value H(k) for 4 T/cycle of B(k)y(k) can be represented by Expression (21).

$$\begin{matrix}H ( k ) = {\sum }_{i = 0}^{N} B ( i ) y ( i ) \\ = G 0 * sin ( H 0 ) * \{ {cos}^{2} ( {h}_{0} ) + {cos}^{2} ( {h}_{1} ) + \\ {cos}^{2} ( {h}_{2} ) + {cos}^{2} ( {h}_{3} ) + … + {cos}^{2} ( {h}_{N - 1} ) \} \\ = G 0 * sin ( H 0 ) * \{ {( \sqrt{2} / 2 )}^{2} * ( 1 + 1 + 1 + 1 + … + 1 ) \} \\ = ( N / 2 ) * G 0 * sin ( H 0 )\end{matrix} \qquad ( 21 )$$

According to the fundamental technique of orthogonal detection, the amplitude GO can be calculated with the use of Expression (22) and the phase can be calculated with the use of Expression (23) based on Expressions (15) and (21). However, when the phase shift is minimum, in other words, in the neighborhood of the phase difference H0=0, approximate values can be found as cos(H0)=1, sin(H0)=H0. Hence, it can be determined that no significant problem arises even if the AGC process is performed based on G(k) and the PLL process is performed based on H(k) as described above. In addition, since the operations of Expressions (22) and (23) are not required, the processing circuit can be simplified.

$$\begin{matrix}AmplitudeG 0 = \frac{N}{2} \sqrt{{G ( k )}^{2} + {H ( k )}^{2}} & ( 22 ) \\ PhaseH 0 = arctan ( \frac{H ( k )}{G ( k )} ) & ( 23 )\end{matrix}$$

Next, the process when the occupancy of the magnetic portion in the preamble area is approximately 66.7% as in the first embodiment is described. In this case, the actual analog preamble reproduction signal exhibits a distorted wave form different from the pseudo sine wave as shown in FIGS. 4A and B.

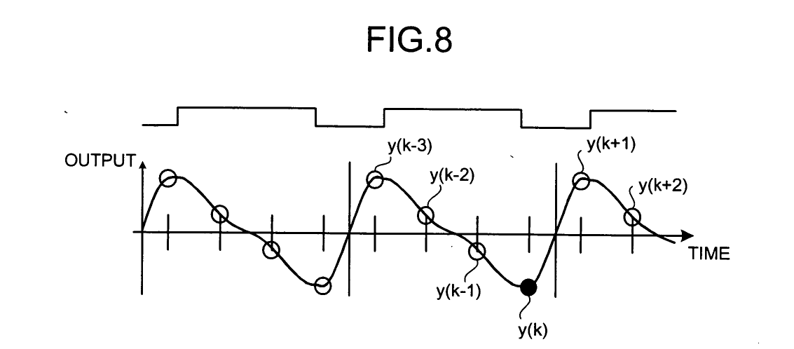

FIG. 8 is a diagram of sampling points of the in-phase preamble reproduction signal. As shown in FIG. 8, the sampled values are different from the sampled values shown in FIG. 6. The analog preamble reproduction signal can be approximated by a wave form containing a harmonic component as represented by Expression (24).

$$\begin{matrix}y ( k ) = G 0 * \{ sin ( 2 π k / N + H 0 + π / N ) + g * \\ sin ( 2 * ( 2 π k / N + H 0 + π / N ) ) \} \\ = G 0 * \{ sin ( ( 2 k + 1 ) π / N + H 0 ) + g * \\ sin ( 2 * ( ( 2 k + 1 ) π / N + H 0 ) ) \}\end{matrix} \\ N = 4 , k = 0 , 1 , 2 , 3 \qquad ( 24 )$$

G0: Amplitude, H0: PhaseDifference

If hₖ=(2k+1)p/N is substituted into Expression (24), Expression (24) can be transformed into Expression (25).

$$\begin{matrix}y ( k ) = G 0 * \{ sin ( {h}_{k} + H 0 ) + g * sin ( 2 * ( {h}_{k} + H 0 ) ) \} \\ = G 0 * \{ sin ( {h}_{k} + H 0 ) + 2 * g * sin ( {h}_{k} + H 0 ) cos ( {h}_{k} + H 0 ) \} \\ = G 0 * sin ( {h}_{k} + H 0 ) * \{ 1 + 2 * g * cos ( {h}_{k} + H 0 ) \} \\ = G 0 * \{ sin ( {h}_{k} ) cos ( H 0 ) + cos ( {h}_{k} ) sin ( H 0 ) \} * \\ \{ 1 + 2 * g * cos ( {h}_{k} ) cos ( H 0 ) \cdot sin ( {h}_{k} ) sin ( H 0 ) \}\end{matrix} \\ Here , {h}_{k} = ( 2 k + 1 ) π / N \qquad ( 25 )$$

Here, the multiplication of the factor of the orthogonal detection A(k)=sin(hₖ) in Expression (26) with the sampled value y(k) results in Expression (27).

$$\begin{matrix}A ( k ) = sin ( {h}_{k} ) & ( 26 ) \\ \begin{matrix}A ( k ) y ( k ) = G 0 * \{ {sin}^{2} ( {h}_{k} ) cos ( H 0 ) + sin ( {h}_{k} ) cos ( {h}_{k} ) \\ sin ( H 0 ) \} * \{ 1 + 2 * g * [ cos ( {h}_{k} ) cos ( H 0 ) - \\ sin ( {h}_{k} ) sin ( H 0 ) ] \} \\ = G 0 * \{ {sin}^{2} ( {h}_{k} ) cos ( H 0 ) + sin ( {h}_{k} ) cos ( {h}_{k} ) \\ sin ( H 0 ) \} + 2 * g * G 0 * \{ {sin}^{2} ( {h}_{k} ) cos ( H 0 ) + \\ sin ( {h}_{k} ) cos ( {h}_{k} ) sin ( H 0 ) \} * [ cos ( {h}_{k} ) cos ( H 0 ) - \\ sin ( {h}_{k} ) sin ( H 0 ) ] \\ = G 0 * \{ {sin}^{2} ( {h}_{k} ) cos ( H 0 ) + sin ( {h}_{k} ) cos ( {h}_{k} ) \\ sin ( H 0 ) \} + 2 * g * G 0 * \{ ( {cos}^{2} ( H 0 ) - {sin}^{2} ( H 0 ) ) * \\ ( cos ( {h}_{k} ) - {cos}^{3} ( {h}_{k} ) ) + sin ( H 0 ) cos ( H 0 ) ( sin ( {h}_{k} ) \\ cos ( {h}_{k} ) - {sin}^{3} ( {h}_{k} ) ) \}\end{matrix} & ( 27 )\end{matrix}$$

When the A(k)y(k) is integrated for 4 T/cycle, the integrated value G(k) is represented by Expressions (28)-(30).

$$\begin{matrix}\begin{matrix}G ( k ) = {\int }_{0}^{4 T} A ( k ) y ( k ) \\ = {\int }_{0}^{4 T} G 0 * \{ {sin}^{2} ( {h}_{k} ) cos ( H 0 ) + sin ( {h}_{k} ) \\ cos ( {h}_{k} ) sin ( H0 ) \} ⅆ k + {\int }_{0}^{4 T} 2 * g * G 0 * \\ \{ ( {cos}^{2} ( H 0 ) - {sin}^{2} ( H 0 ) ) * ( cos ( {h}_{k} ) - \\ {cos}^{3} ( {h}_{k} ) ) \} ⅆ k + {\int }_{0}^{4 T} 2 * g * G 0 * sin \\ ( H 0 ) cos ( H 0 ) ( sin ( {h}_{k} ) cos ( {h}_{k} ) - {sin}^{3} ( {h}_{k} ) ) ⅆ k\end{matrix} & ( 28 ) \\ \begin{matrix}= G 0 * cos ( H 0 ) {\int }_{0}^{4 T} {sin}^{2} ( {h}_{k} ) ⅆ k + \\ G 0 * sin ( H 0 ) {\int }_{0}^{4 T} sin ( {h}_{k} ) cos ( {h}_{k} ) ⅆ k + \\ 2 * g * G 0 * ( {cos}^{2} ( H 0 ) - {sin}^{2} ( H 0 ) ) \\ {\int }_{0}^{4 T} \{ cos ( {h}_{k} ) - {cos}^{3} ( {h}_{k} ) \} ⅆ k + 2 * g * G 0 * sin ( H 0 ) \\ cos ( H 0 ) {\int }_{0}^{4 T} \{ sin ( {h}_{k} ) cos ( {h}_{k} ) - {sin}^{3} ( {h}_{k} ) \} ⅆ k\end{matrix} & ( 29 ) \\ = G 0 * cos ( H 0 ) {\int }_{0}^{4 T} {sin}^{2} ( {h}_{k} ) ⅆ k & ( 30 )\end{matrix}$$

The first term in Expression (28) can be transformed as the first and the second terms of Expression (29) similarly to Expression (13) described above, and the second and the third terms of Expression (28) can be transformed as the third and the fourth terms of Expression (29). Here, the integrated value for 4 T/cycle of sin(hₖ)cos(hₖ) in the second term of Expression (29) is zero as in Expression (13). Further, in the third and the fourth terms of Expression (29), since cos(hₖ), and cos³(hₖ) are cosine functions of an odd order, the integrated value for one cycle of cos(hₖ), and cos³(hₖ) are both zero. Hence, the third and the fourth terms of Expression (29) also produce zero, and the value G(k) can be expressed by Expression (30). The Expression (30) is same with Expression. (13), and hence, the integrated value G(k) for 4 T/cycle of A(k)y(k) can be represented by Expression (31) similarly to Expression (15).
G(k)=(N/2)*G0*cos(H0) (31)

On the other hand, the multiplication of the factor of the orthogonal detection B(k)=cos(hₖ) shown in Expression (32) with the sampled value y(k) results in Expression (33).

$$\begin{matrix}B ( k ) = cos ( {h}_{k} ) & ( 32 ) \\ \begin{matrix}B ( k ) y ( k ) = G 0 * \{ cos ( {h}_{k} ) sin ( {h}_{k} ) cos ( H 0 ) + \\ {cos}^{2} ( {h}_{k} ) sin ( H 0 ) \} * \{ 1 + 2 * g * ( H 0 ] \\ [ cos ( {h}_{k} ) cos ( H 0 ) - sin ( {h}_{k} ) sin \} \\ = G 0 * \{ cos ( {h}_{k} ) sin ( {h}_{k} ) cos ( H 0 ) + \\ {cos}^{2} ( {h}_{k} ) sin ( H0 ) \} + 2 * g * G 0 * \\ \{ cos ( {h}_{k} ) sin ( {h}_{k} ) cos ( H 0 ) + {cos}^{2} ( {h}_{k} ) sin ( H 0 ) \} * \\ \{ cos ( {h}_{k} ) cos ( H 0 ) - sin ( {h}_{k} ) sin ( H 0 ) \} \\ = G 0 * \{ cos ( {h}_{k} ) sin ( {h}_{k} ) cos ( H 0 ) + {cos}^{2} ( {h}_{k} ) sin \\ ( H 0 ) \} + 2 * g * G 0 * \{ ( {cos}^{2} ( H 0 ) - {sin}^{2} ( H 0 ) ) * \\ ( sin ( {h}_{k} ) - {sin}^{3} ( {h}_{k} ) ) + sin ( H 0 ) cos ( H 0 ) \\ ( 2 {cos}^{3} ( {h}_{k} ) - cos ( {h}_{k} ) ) \}\end{matrix} & ( 33 )\end{matrix}$$

When the B(k)y(k) is integrated for 4 T/cycle, the integrated value H(k) can be represented by Expressions (34)-(36).

$$\begin{matrix}\begin{matrix}H ( k ) = {\int }_{0}^{4 T} B ( k ) y ( k ) \\ = {\int }_{0}^{4 T} G 0 * \{ cos ( {h}_{k} ) sin ( {h}_{k} ) cos ( H 0 ) + {cos}^{2} \\ ( {h}_{k} ) sin ( H0 ) \} ⅆ k + {\int }_{0}^{4 T} 2 * g * G 0 * \{ ( {cos}^{2} ( H 0 ) - \\ {sin}^{2} ( H 0 ) ) * ( sin ( {h}_{k} ) - {sin}^{3} ( {h}_{k} ) ) \} ⅆ k + \\ {\int }_{0}^{4 T} 2 * g * G 0 * sin ( H 0 ) cos ( H 0 ) \\ ( 2 {cos}^{3} ( {h}_{k} ) - cos ( {h}_{k} ) ) \text{\}} ⅆ k\end{matrix} & ( 34 ) \\ \begin{matrix}= G 0 * cos ( H 0 ) {\int }_{0}^{4 T} cos ( {h}_{k} ) sin ( {h}_{k} ) ⅆ k + \\ G 0 * sin ( H 0 ) {\int }_{0}^{4 T} {cos}^{2} ( {h}_{k} ) ⅆ k + \\ 2 * g * G 0 * ( {cos}^{2} ( H 0 ) - {sin}^{2} ( H 0 ) ) \\ {\int }_{0}^{4 T} \{ sin ( {h}_{k} ) - {sin}^{3} ( {h}_{k} ) \} ⅆ k + 2 * g * G 0 * sin \\ ( H 0 ) cos ( H 0 ) {\int }_{0}^{4 T} \{ 2 {cos}^{3} ( {h}_{k} ) - cos ( {h}_{k} ) \} ⅆ k\end{matrix} & ( 35 ) \\ = G 0 * sin ( H 0 ) {\int }_{0}^{4 T} {cos}^{2} ( {h}_{k} ) ⅆ k & ( 36 )\end{matrix}$$

The first term of Expression (34) can be transformed as the first and the second terms of Expression (35) similarly to Expression (19), and the second and the third terms of Expression (34) can be transformed as the third and the fourth terms of Expression (35). Here, in the first term of Expression (35), the integrated value for 4 T/cycle of cos(hₖ)sin(hₖ) is zero similarly to Expression (19). In addition, in the third and the fourth terms of Expression (35), since sin(hₖ), and sin³(hₖ) are sine functions of an odd order, the integrated value for one cycle of sin(hₖ) and sin³(hₖ) are both zero. Hence, the third and the fourth terms of Expression (29) are also zero and H(k) is represented only with the second term of Expression (35) similarly to Expression (36). The Expression (36) is same with Expression (19) and hence, the integrated value H(k) for 4 T/cycle of B(k)y(k) can be represented by Expression (37) similarly to Expression (21).
H(k)=(N12)*G0*sin(H0) (37)

Thus, since Expression (31) and Expression (15) for G(k) are same and Expression (37) and Expression (21) for H(k) are same, when the phase shift is small, i.e., in the neighborhood of the phase difference H0=0, the approximation of cos(H0)=1 and sin(H0)=H0 holds as in Expressions (15) and (21). Hence, it can be determined that the AGC process based on G(k) and the PLL process based on H(k) do not incur inconveniences. In other words, even when the AGC process and the PLL process similar to the conventional process are performed in the magnetic recording medium of the first embodiment, the amplitude G0 and the phase difference H0 can be detected without any problems.

The signal amplitude G0 is, however, not the amplitude for the pseudo sine wave but the amplitude of the distorted wave form under the influence of the harmonic component. Hence, the gain control needs to be conducted in view of the distortion in the AGC process (AGC adjustment gain).

Here, when the difference in the occupancy of the magnetic portion in the data area 100 and the preamble area 111 is within the range of approximately 10%, the equalization signal obtained as a result of filtering for an exposed hole by the equalizer 501 can be treated as an equivalent to the longitudinal recording reproduction signal without significant problem.

Thus, in the magnetic recording medium according to the first embodiment, the occupancy of the magnetic portion in the preamble area 111 is equal to the occupancy of the magnetic portion in the data area 100, or the difference in the occupancies in these areas is within the range of approximately 10%. Hence, the ratio of depressions/protrusions of the stamper to be utilized at the formation of the magnetic surface can be made substantially uniform on the entire surface. Thus, the variations in the stress that works at the imprinting on the magnetic recording medium is minimum, whereby the manufacturing of the magnetic recording medium is allowed with the stable full-imprinting by the stamper.

In addition, since the stable full-imprinting is performed for the magnetic recording medium according to the first embodiment, frequency of errors in servo information reading can be reduced when the magnetic recording medium is inserted into the drive, whereby the significant improvement in the yield is realized.

In the description of the first embodiment, specific values are shown as the occupancy of the magnetic portion in the preamble area. However, any occupancy of the magnetic portion is adoptable as far as the occupancy is substantially equal to the occupancy of the magnetic portion in the data area, and the above-described value is not a limiting example. For example, the occupancy of the magnetic portion substantially equal to the ratio in the data area might be ±10% of the occupancy of the magnetic portion in the data area as described above. In the magnetic recording medium, the ratio may divert from such range as far as the ratio is approximate to such value as to allow the stable full-imprinting.

In the first embodiment, the magnetic recording medium has the preamble area where the ratio of the magnetic portion to the non-magnetic portion is 2:1. In a magnetic recording medium according to a second embodiment, the ratio of the magnetic portion to the non-magnetic portion in the preamble area is 1:2.

The magnetic recording medium according to the second embodiment, similarly to the magnetic recording medium according to the first embodiment shown in FIG. 1, is divided into a plurality of sectors in a peripheral direction and each sector has a servo area.

In the magnetic recording medium according to the second embodiment, the magnetic portion of the data area is regularly interspaced by the non-magnetic portions, and plural separate magnetic portions are regularly arranged in the data area. The data area where such separate magnetic portions are imprinted, the occupancy of the magnetic portion is approximately 35%.

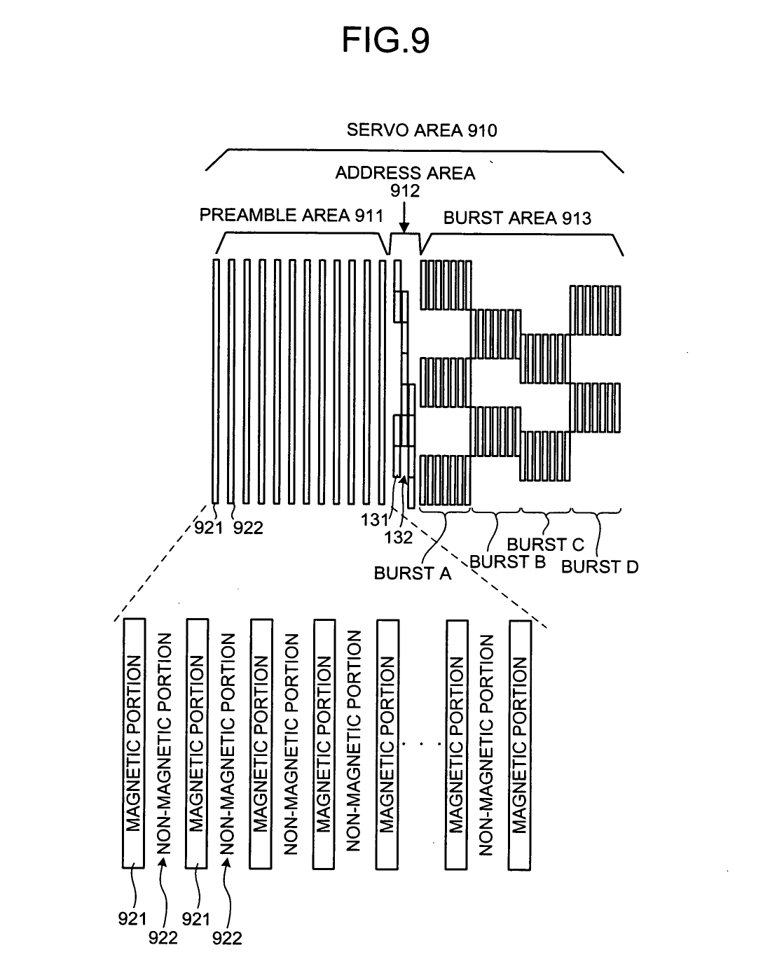

FIG. 9 is a schematic diagram of a structure of the servo area of the magnetic recording medium according to the second embodiment. A servo area 910 of the magnetic recording medium according to the second embodiment includes a preamble area 911, an address area 912, and a burst area 913 similarly to the magnetic recording medium according to the first embodiment.

In the preamble area 911 of the servo area 910 according to the second embodiment, the ratio of the width in the track direction of a magnetic portion 921 to a non-magnetic portion 922 is 1:2. Hence, the occupancy of the magnetic portion in the preamble area 911 is approximately 33.3%, whereas the occupancy of the magnetic portion in the data area is 35%, whereby the difference therebetween is within the range of 10%. Here, the occupancy of the magnetic portion in the address area 912 is approximately 50%, whereas the occupancy of the magnetic portion in the burst area 913 is approximately 25%.

In the magnetic recording medium according to the second embodiment, the ratio of the magnetic portion 922 to the non-magnetic portion 922 in the preamble area 911 is reverse to the ratio of the magnetic portion to the non-magnetic portion in the preamble area of the magnetic recording medium according to the first embodiment. With the inversion of the polarity, the reproduction signal from the preamble area of the first embodiment can be regarded substantially the same with the reproduction signal from the servo area 910. Hence, the AGC process and the PLL process of the preamble reproduction signal can be performed similarly to the first embodiment.

In the magnetic recording medium according to the second embodiment, the occupancy of the magnetic portion is approximately 35% in the data area, approximately 33.3% in the preamble area 911, approximately 50% in the address area 912, and approximately 25% in the burst area 913. Hence, the expansion ratio at the thermal imprinting is expected to be different in the address area 912 compared with other areas. The address area 912, however, is present only in an extremely limited area in comparison with other areas, and hence, the difference in the expansion ratio does not cause significant problems.

Since in the magnetic recording medium according to the second embodiment, the ratio of the magnetic portion to the non-magnetic portion in the preamble area 911 is 1:2, the ratio of the depressions/protrusions of the stamper used for the formation of the magnetic surface is substantially uniform on the entire surface. Hence, the variations in the stress that works on the magnetic recording medium at the imprinting is minimum and the manufacturing of the magnetic recording medium is allowed with stable full-imprinting by the stamper.

In the description of the second embodiment, specific values are shown as the occupancy of the magnetic portion in the preamble area. However, any occupancy of the magnetic portion is adoptable as far as the ratio is substantially equal to the occupancy of the magnetic portion in the data area, and the above-described value is not a limiting example. For example, the occupancy of the magnetic portion substantially equal to the ratio in the data area might be approximately ±10% of the occupancy of the magnetic portion in the data area. In the magnetic recording medium, the ratio may divert from such range as far as the ratio is approximate to such value as to allow the stable full-imprinting.

In the magnetic recording medium according to the first embodiment, the ratio of the width in the track direction of the magnetic portion to the non-magnetic portion of the preamble area 111 is 2:1, whereby the occupancy of the magnetic portion in the preamble area 111 is approximately 66.7% which is substantially equal to the occupancy of the magnetic portion in the data area 100. In a magnetic recording medium according to a third embodiment, however, the ratio of the width in the track direction of the magnetic portion to the non-magnetic portion remains to be 1:1. In the magnetic recording medium according to the third embodiment, the arrangement of the magnetic portion and the non-magnetic portion is modified. A set of two magnetic portions indicating “1” followed by one non-magnetic portion indicating “0” is arranged along the peripheral direction of the magnetic recording medium, so that the reproduced preamble reproduction signal is “1,1,0” in one cycle. Thus, the occupancy of the magnetic portion in the preamble area is made approximately 66.7%.

The magnetic recording medium according to the third embodiment is divided into a plurality of sectors along the peripheral direction and each sector has a servo area similarly to the magnetic recording medium according to the first embodiment shown in FIG. 1.

The magnetic recording medium according to the third embodiment is a discrete track type medium similar to the first embodiment. The occupancies of the magnetic portion in respective areas are, similarly to the first embodiment, approximately 66.7% in the data area, approximately 66.7% in the preamble area, approximately 50% in the address area, and approximately 75% in the burst area.

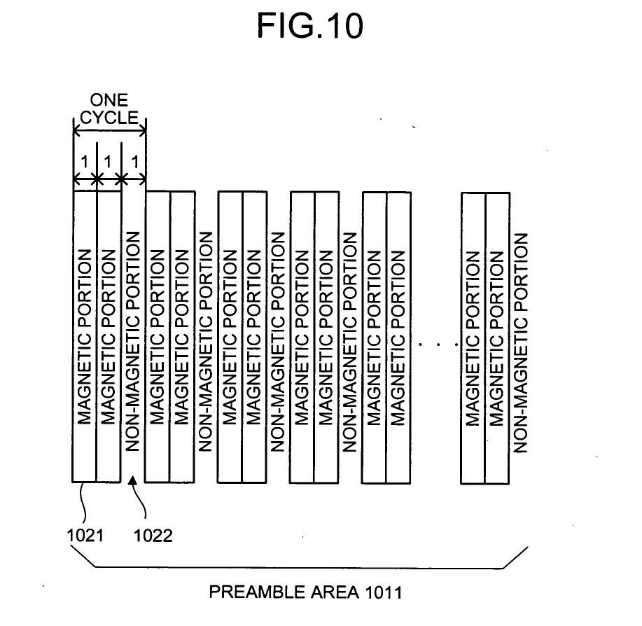

FIG. 10 is a schematic diagram of a structure of a preamble area 1101 in the servo area of the magnetic recording medium according to the third embodiment. In the preamble area 1101 of the magnetic recording medium of the third embodiment, a magnetic portion 1021 indicating a binary value “1” and a non-magnetic portion 1022 indicating a binary value “0” are formed with the same width in the track direction. The magnetic portion and the non-magnetic portion are arranged so that one cycle of the preamble reproduction signal is consisted from “1,1,0,” in other words, two magnetic portions 1021 followed by one non-magnetic portion 1022 constitute a set and the sets are arranged along the peripheral direction.

For the manufacturing of the magnetic recording medium with such a structure according to the third embodiment, a signal source for the recording of the preamble signals is arranged as to repeat “1” (magnetic portion), “1” (magnetic portion), and “0” (non-magnetic portion) at the fabrication of the stamper. Thus, the processing for the master disk recording can be remarkably simplified.

Next, a magnetic recording/reproducing apparatus that reproduces the data from the magnetic recording medium according to the embodiments is described.

It has been described above in relation to the first embodiment that the similar detection performance can be achieved in principle even when the occupancy of the magnetic portion in the preamble area is different from that in the conventional magnetic recording medium via the AGC process and the PLL process similar to the conventional processes. However, in an actual processing, the time required for the synchronization becomes longer than that in the conventional magnetic recording medium. The cause of such inconvenience is that when the occupancy of the magnetic portion in the preamble area is 66.7%, the output amplitude of the head amplifier IC (HIC) becomes smaller than the output amplitude in the medium with the occupancy of the magnetic portion of 50% in the preamble area, which leads to a shift in signal to noise ratio of the equalization signal. The decrease in the amplitude is assumed to be derived from an insufficient response, i.e., when the cycle of the preamble reproduction signal is 4 T, the signal length in the non-magnetic portion is 1.3 T which is extremely short to properly lower the signal.

In the magnetic recording medium according to the third embodiment, the signal cycle length in the preamble area 1011 is 1.5 times that in the address area 1012 and the burst area 1013. Specifically, when the cycle length of the reproduction signal in the address area 1012 and the burst area 1013 is 4 T, the cycle length of the reproduction signal in the preamble area 1011 is 6 T, whereby even in the non-magnetic portion the length of 2 T can be secured. In the first embodiment, the signal amplitude decreases below 2 T in the non-magnetic portion to cause degradation in signal to noise ratio. In the third embodiment, since the signal length of 2 T can be secured in the non-magnetic portion 1022, the degradation of the signal to noise ratio does not occur.

However, due to the different cycle length of the reproduction signal in the address area 1012 and the preamble area 1011, some inconvenience arises in the processing of the reproduction signal in the preamble area in the channel. To perform four-point sampling for decoding and reproduction in the address area 1012, six-point sampling needs to be performed in one cycle of the preamble reproduction signal obtained from the preamble area 1011.

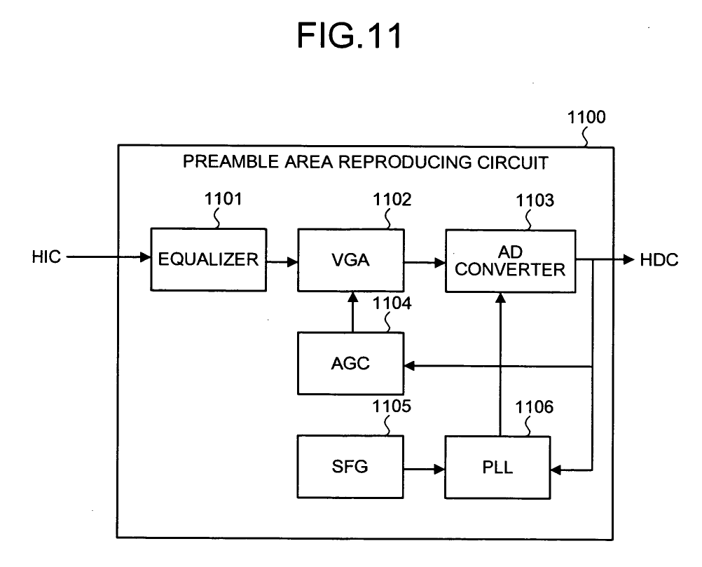

FIG. 11 is a block diagram of a structure of the preamble area reproducing circuit of the magnetic recording/reproducing apparatus according to the third embodiment.

The preamble area reproducing circuit 1100, as shown in FIG. 11, includes an equalizer 1101, a VGA 1102, an AD converter 1103, an AGC circuit 1104, an SFG 1105, and a PLL 1106.

The equalizer 1101, similarly to the first embodiment, performs an analog filtering by an LPF or the like on an analog reproduction signal obtained from the preamble area 1101 to convert the same into an equalization signal corresponding to a longitudinal recording reproduction signal.

The VGA 1102 is a circuit with a variable gain which amplifies the longitudinal equalization signal supplied from the equalizer 1101 similarly to the first embodiment. The VGA 502 adjusts the amplitude of the longitudinal equalization signal to a constant value.

The AD converter 1103 (AD converting unit) converts the analog longitudinal equalization signal after the amplification by the VGA 1102 into a digital signal at a sampling timing following the reproduction clock supplied from the PLL 1106. In the third embodiment, the AD converter 1103 takes samples of the analog longitudinal equalization signal at six points in one cycle.

In the magnetic recording medium according to the third embodiment, the cycle of the preamble reproduction signal is different from the cycles of the reproduction signals obtained in the address area 1012 and the burst area 1013. Specifically, the conventional magnetic recording medium is formed to have a preamble area with the occupancy of the magnetic portion of 50% and the magnetic portion and the non-magnetic portion are arranged to realize the repetition of binary values “1” and “0” of the preamble reproduction signal, and the time required for the inversion of the magnetic polarity in the servo area is set constant. The magnetic recording medium according to the third embodiment, however, is formed to have the magnetic portion 1021 and the non-magnetic portion 1022 arranged as to realize the repetition of “1” “1,” and “0” of the preamble reproduction signal, i.e., two magnetic portions 1021 followed by the non-magnetic portion 1022 forms a set and plural sets are sequentially arranged. Hence, the cycle of the preamble reproduction signal in the third embodiment is not less than 1.5 times the signal cycle in other areas of the servo area.

Hence, the preamble area reproducing circuit 1100 of the third embodiment performs six-point sampling of the preamble reproduction signal in the AGC process and the PLL process of the preamble reproduction signal. In this regards, the preamble area reproducing circuit 1100 of the third embodiment is different from the corresponding component in the first embodiment.

The AGC circuit 1104 (gain controlling unit) detects the amplitude of the preamble reproduction signal from the sampled values at six points in one cycle of the preamble reproduction signal which is a reproduction signal from the preamble area 1011, and controls the gain of the VGA 1102 based on the detected amplitude. The detail of the amplitude detection is described later. The SFG 1105 generates a servo reference clock.

The PLL 1106 (phase adjusting unit) detects the phase difference of the preamble reproduction signal based on the sampled values at six points of the preamble reproduction signal, and adjusts the phase of the servo reference clock generated by the SFG 1105. Further, the PLL 1106 generates a reproduction clock with same N-times cycle and phase with the preamble reproduction signal detected by the AD converter 1103, to realize an appropriate sampling timing for the AD conversion by the AD converter 1101. The detail of the phase difference detection is described later.

Next, the process of preamble signal reproduction by the preamble area reproducing circuit 1100 according to the third embodiment with the structure as described above is described below.

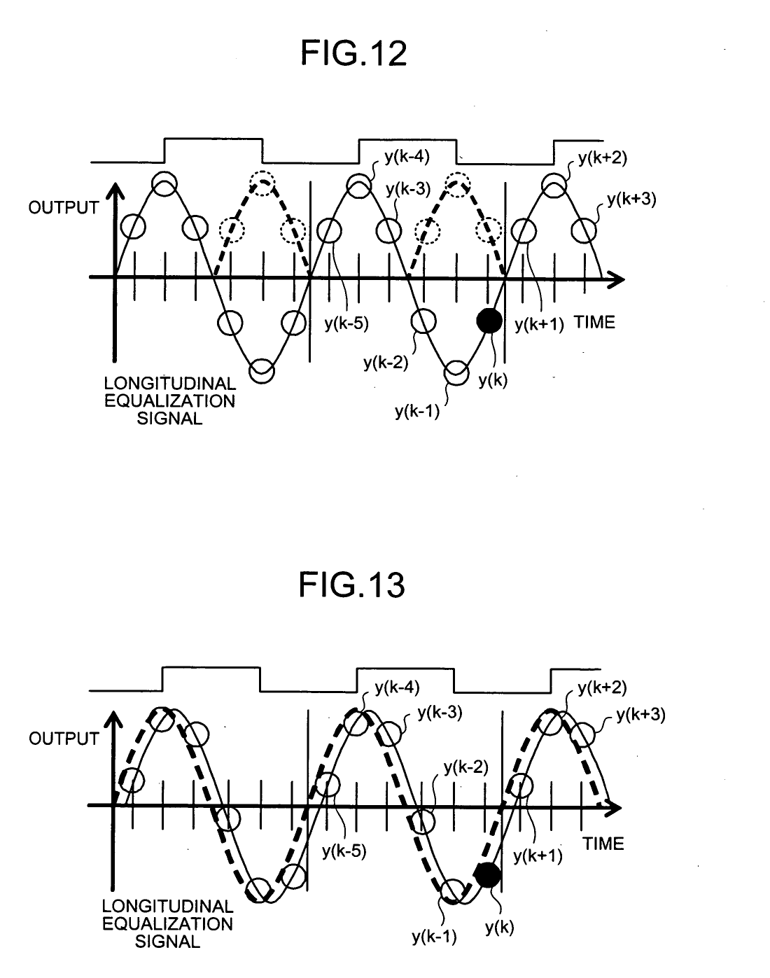

The AGC circuit 1104 needs to detect the amplitude of the preamble reproduction signal at a current time for the control of the gain of the VGA 1102. The process of amplitude detection is described. FIG. 12 is a diagram of a principle of the amplitude detection of the preamble reproduction signal, where the sampling is performed at six points in one cycle of the preamble reproduction signal, i.e., the longitudinal equalization signal, and the phase synchronization by the PLL process has nearly been finished.

In FIG. 12, a solid line represents the preamble reproduction signal after the equalization, and a white circle represents a sampled value taken at each of six points in one cycle. The sampled value y(k) at the current time k is represented by a black circle.

In the third embodiment, the AD converter 1103 realizes six-point sampling per one cycle of the preamble reproduction signal. When the number N of sampling per one cycle of the preamble reproduction signal is six, each sampled value of one cycle of the preamble reproduction signal can be represented as y(k−5), y(k−4), y(k−3), y(k−2), y(k−1), and y(k). When the sampling is performed at k points at the sampling timing as shown in FIG. 12, the inner product produced by the multiplication of the sampled values with the factor [1,2,1,−1,−2,−1] results in the sum of the absolute values at six points represented by a dotted line of the equalization signal.

In other words, the inner product G(k) in proportion to the amplitude can be obtained. If a loop delay is added to the factor [1,2,1,−1,−2,−1], such as [2,1,−1,−2,−1,1], [1,−1,−2,−1,1,2], [−1,−2,−1,1,2,1], [−2,−1,1,2,1,−1 , [−1,1,2,1,−1,−2], and [1,2,1,−1,−2,−1] and different factor is employed for each sampling timing, the inner product always attains the value of the sum of the absolute values at six points of the longitudinal equalization signal. For example, if [y(k−4),y(k−3),y(k−2),y(k−1),y(k),y(k+1)], [y(k−3),y(k−2),y(k−1),y(k),y(k+1),y(k+2)], [y(k−2),y(k−1),y(k),y(k+1),y(k+2),y(k+3)], [y(k−1),y(k),y(k+1),y(k+2),y(k+3),y(k+4)], [y(k),y(k+1),y(k+2),y(k+3),y(k+4),y(k+5)] are multiplied respectively by factors [2,1,−1,−2,−1,1], [1,−1,−2,−1,1,2,], [−1,−2,−1,1,2,1], [−2,−1,1,2,1,−1], and [−1,1,2,1,−1,−2] the result is always the sum of the absolute values at six points of the longitudinal equalization signal. The AGC circuit 1104 sequentially compares the resulting sum and a reference value to change the gain of the VGA 1102 according to the result of comparison, whereby the amplitude of the preamble signal can be adjusted to be a predetermined value.

Next, the PLL process by the PLL 1106 is described. To realize the PLL process, the phase shift (phase difference) of the longitudinal equalization signal needs to be detected for the adjustment of the sampling timing. FIG. 13 is a diagram of a principle of the phase difference detection for the PLL process by the preamble area reproducing circuit 1100 according to the third embodiment. A dotted line in FIG. 13 represents the longitudinal equalization signal perfectly in phase whereas a solid line represents the longitudinal equalization signal with a slight phase delay.

As can be seen from FIG. 13, when the phase difference is zero and the signal is perfectly in phase (as shown by the dotted line), the relation represented by Expression (38) holds for each sampled value.
y(k−5)=y(k−3), y(k−2)=y(k) (38)

In other words, when the inner product H(k) is calculated with the factor [1,0,−1,−1,0,1] for the six points in a cycle of the preamble reproduction signal [y(k−5),y(k−4),y(k−3),y(k−2),y(k−1),y(k)], the result is H(k)=0. Further, when factors are set to have a loop delay similarly to the AGC process, H(k)=0 holds for each sampled value. In other words, when [y(k−4),y(k−3),y(k−2),y(k−1),y(k),y(k+1)], [y(k−3),y(k−2),y(k−1),y(k),y(k+1),y(k+2)], [y(k−2),y(k−1),y(k),y(k+1),y(k+2),y(k+3)], [y(k−1),y(k),y(k+1),y(k+2),y(k+3),y(k+4)], and [y(k),y(k+1),y(k+2),y(k+3),y(k+4),y(k+5)] are multiplied with factors [o,−1,−1,0,1,1], [−1,1,0,1,1,0], [−1,0,1,1,0,−1], [0,1,1,0,−1,−1] and [1,1,0,−1,−1,0], respectively, H(k)=0 is obtained for each sampled value.

On the other hand, when there is a slight phase delay as shown in FIG. 13 (the solid line), the relation represented by Expression (39) holds for each sampled value.
y(k−5)<y(k−3), −y(k−2)<−y(k) (39)

Then, when the factor for the six points/cycle of the preamble reproduction signal is set as [1,0,−1,−1,0,1], the inner product H(k) is less than zero (H(k)<0), whereby the phase delay can be detected based on the value of H(k).

When the time of the k point sequentially changes, the inner product H(k) with the factors set to have the loop delay is always constant. When the phase is ahead, the relation represented by Expression (40) holds for each sampled value.
y(k−5)>y(k−3), −y(k−2)>−y(k) (40)

Hence, when the factor for six points/cycle of the preamble reproduction signal is set as [1,0,−1,−1,0,1], the inner product H(k) is always larger than zero (H(k)>0), and the phase is determined to be ahead.

Thus, the PLL 1106 calculates the inner product H(k) as described above, detects the phase difference based on the calculated inner product H(k), and adjusts the delay of the servo reference clock utilizing a voltage controlled oscillator (VCO) inside the PLL 1106, thereby realizing the synchronization of the reproduction signal with the clock.

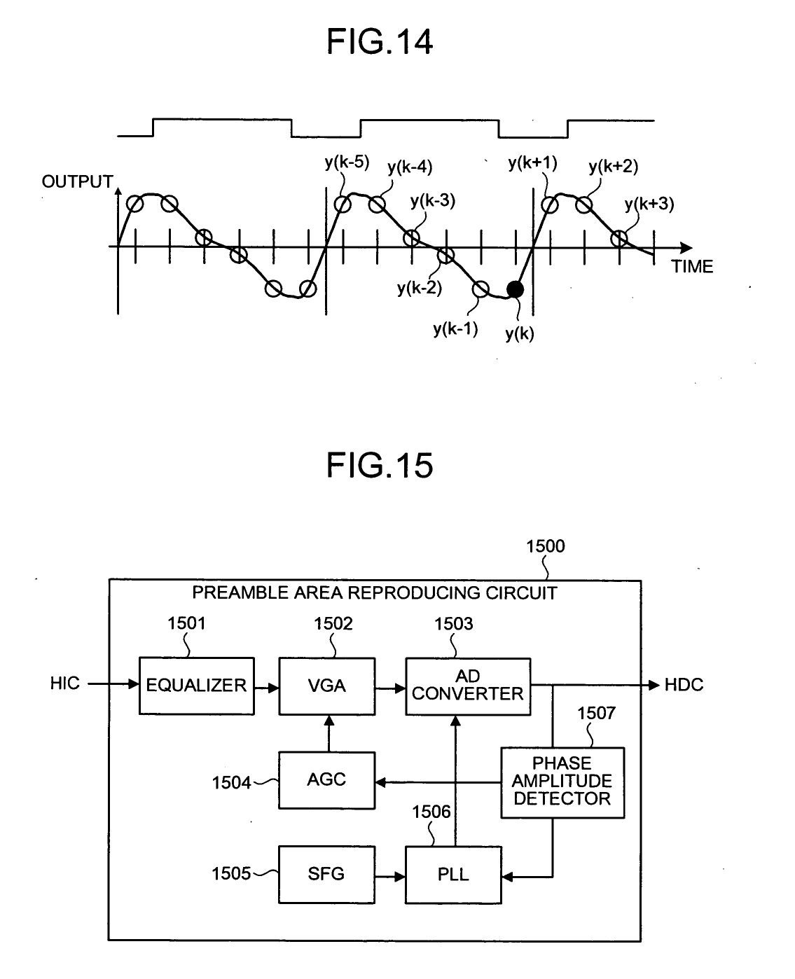

The analog preamble reproduction signal obtained when the occupancy of the magnetic portion in the preamble area is approximately 66.7% as in the third embodiment exhibits a distorted wave form different from the pseudo sine wave. FIG. 14 is a diagram of sample points of the in-phase preamble reproduction signal. The analog preamble reproduction signal can be approximated to a wave form containing a harmonic component as represented by the following Expression (41).

$$\begin{matrix}y ( k ) = G 0 * \{ sin ( 2 π k / 6 + H 0 + π / 6 ) + g * \\ sin ( 2 * ( 2 π k / 6 + H 0 + π / 6 ) ) \} \\ = G 0 * \{ sin ( ( 2 k + 1 ) π / 6 + H 0 ) + g * sin \\ ( 2 * ( ( 2 k + 1 ) π / 6 + ( H 0 ) ) \}\end{matrix} \\ N = 6 , k = 0 , 1 , 2 , 3 , 4 , 5 , \\ G 0 \text{:} Amplitude H 0 \text{:} PhaseDifference \qquad ( 41 )$$

The sampled values y(0), y(1), y(2), y(3), y(4), and y(5) at six points in one cycle can be represented by following Expressions (42) to (47) based on Expression (41).
y(0)=G0*sin(π/6+H0)+g*sin(π/6+H0) (42)
y(1)=G0*sin(3π/6+H0)+g*sin(3π/6+H0) (43)
y(2)=G0*sin(5π/6+H0)+g*sin(5π/6+H0) (44)
y(3)=G0*sin(7π/6+H0)+g*sin(7π/6+H0) (45)
y(4)=G0*sin(9π/6+H0)+g*sin(9π/6+H0) (46)
y(5)=G0*sin(11π/6+H0)+g*sin(11π/6+H0) (47)

In addition, if hₖ=(2k+1)p/6 in Expression (41), Expression (41) is transformed into the following Expression (48).

$$\begin{matrix}y ( k ) = G 0 * \{ sin ( {h}_{k} + H 0 ) + g * sin ( 2 * ( {h}_{k} + H 0 ) ) \} \\ = G 0 * \{ sin ( {h}_{k} + H 0 ) + 2 * g * sin \\ ( {h}_{k} + H 0 ) cos ( {h}_{k} + H 0 ) \} \\ = G 0 * sin ( {h}_{k} + H 0 ) * \{ 1 + 2 * g * cos ( {h}_{k} + H 0 ) \} \\ = G 0 * \{ sin ( {h}_{k} ) cos ( H 0 ) + cos ( {h}_{k} ) sin ( H 0 ) \} * \\ \{ 1 + 2 * g * cos ( {h}_{k} ) cos ( H 0 ) - sin ( {h}_{k} ) sin ( H 0 ) \}\end{matrix} \\ Here , {h}_{k} = ( 2 k + 1 ) π / 6 \qquad ( 48 )$$

Here, if the factor of the orthogonal detection represented by Expression (49), i.e., A(k)=sin(hₖ) is set as the factors [1,2,1,−1,−2,−1] for finding the inner product G(k) proportional to the amplitude as described above, and multiplied by the sampled value y(k), the following Expression (50) is obtained.

$$\begin{matrix}\begin{matrix}A ( k ) = sin ( {h}_{k} ) \\ = [ A ( 0 ) , A ( 1 ) , A ( 2 ) , A ( 3 ) , A ( 4 ) , A ( 5 ) ] \\ = ( 1 / 2 ) * [ 1 , 2 , 1 , - 1 , - 2 , - 1 ]\end{matrix} & ( 49 ) \\ \begin{matrix}A ( k ) y ( k ) = G 0 * \{ {sin}^{2} ( {h}_{k} ) cos ( H 0 ) + sin ( {h}_{k} ) \\ cos ( {h}_{k} ) sin ( H 0 ) \} * \{ 1 + 2 * g * [ cos ( {h}_{k} ) \\ cos ( H 0 ) - sin ( {h}_{k} ) sin ( H0 ) ] \} \\ = G 0 * \{ {sin}^{2} ( {h}_{k} ) cos ( H 0 ) + sin ( {h}_{k} ) cos \\ ( {h}_{k} ) sin ( H 0 ) \} + 2 * g * G 0 * \{ {sin}^{2} ( {h}_{k} ) cos ( H 0 ) + \\ sin ( {h}_{k} ) cos ( {h}_{k} ) sin ( H 0 ) \} * \\ [ cos ( {h}_{k} ) cos ( H 0 ) - sin ( {h}_{k} ) sin ( H 0 ) ] \\ = G 0 * \{ {sin}^{2} ( {h}_{k} ) cos ( H 0 ) + sin ( {h}_{k} ) \\ cos ( {h}_{k} ) sin ( H 0 ) \} + 2 * g * G 0 * \{ ( {cos}^{2} ( H 0 ) - \\ {sin}^{2} ( H 0 ) ) * ( cos ( {h}_{k} ) - {cos}^{3} ( {h}_{k} ) ) + sin ( H0 ) cos \\ ( H 0 ) ( sin ( {h}_{k} ) cos ( {h}_{k} ) - {sin}^{3} ( {h}_{k} ) ) \}\end{matrix} & ( 50 )\end{matrix}$$

If the value A(k)y(k) is integrated for 6 T/cycle, the integrated value G(k) is represented by Expressions (51) to (53).

$$\begin{matrix}\begin{matrix}G ( k ) = {\int }_{0}^{6 T} A ( k ) y ( k ) \\ = {\int }_{0}^{6 T} G 0 * \{ {sin}^{2} ( {h}_{k} ) cos ( H 0 ) + sin ( {h}_{k} ) cos ( {h}_{k} ) \\ sin ( H0 ) \} ⅆ k + {\int }_{0}^{6 T} 2 * g * G 0 * \{ ( {cos}^{2} ( H 0 ) - \\ {sin}^{2} ( H 0 ) ) * ( cos ( {h}_{k} ) - {cos}^{3} ( {h}_{k} ) ) \} ⅆ k + \\ {\int }_{0}^{6 T} 2 * g * G 0 * sin ( H 0 ) cos ( H 0 ) \\ ( sin ( {h}_{k} ) cos ( {h}_{k} ) - {sin}^{3} ( {h}_{k} ) ) \} ⅆ k\end{matrix} & ( 51 ) \\ \begin{matrix}= G 0 * cos ( H 0 ) {\int }_{0}^{6 T} {sin}^{2} ( {h}_{k} ) ⅆ k + \\ G 0 * sin ( H 0 ) {\int }_{0}^{6 T} sin ( {h}_{k} ) cos ( {h}_{k} ) ⅆ k + \\ 2 * g * G 0 * ( {cos}^{2} ( H 0 ) - {sin}^{2} ( H 0 ) ) \\ {\int }_{0}^{6 T} \{ cos ( {h}_{k} ) - {cos}^{3} ( {h}_{k} ) \} ⅆ k + 2 * g * G 0 * sin \\ ( H 0 ) cos ( H 0 ) {\int }_{0}^{6 T} \{ sin ( {h}_{k} ) cos ( {h}_{k} ) - {sin}^{3} ( {h}_{k} ) \} ⅆ k\end{matrix} & ( 52 ) \\ = G 0 * cos ( H 0 ) {\int }_{0}^{6 T} {sin}^{2} ( {h}_{k} ) ⅆ k & ( 53 )\end{matrix}$$

As shown in Expressions (51) to (53), the integrated value for 6 T/cycle of sin(hₖ)cos(hₖ) is zero, and the integrated value for 6 T/cycle of cos(hₖ), cos³(hₖ), and sin³(hₖ) are zero. Hence, the integrated value G(k) eventually is only the term of the integrated value of sin²(hₖ). Further, the integrated value G(k) of 6 T/cycle is equivalent to the inner product of the sampled values of six points y(k) and the factors A(k) (here, k=0,1,2,3,4,5). Still further, the integrated value G(k) for 6 T/cycle of A(k)y(k) is only the term of the integrated value sin²(hₖ) as in Expression (53), and the factor A(k) can be represented by Expression (49), and hence, the integrated value G(k) for 6 T/cycle of A(k)y(k) can be calculated as shown by Expression (54).

$$\begin{matrix}G ( k ) = {\sum }_{i = 0}^{5} A ( i ) y ( i ) \\ = G 0 * cos ( H 0 ) * \{ {sin}^{2} ( {h}_{0} ) + {sin}^{2} ( {h}_{1} ) + {sin}^{2} ( {h}_{2} ) + \\ {sin}^{2} ( {h}_{3} ) + {sin}^{2} ( {h}_{4} ) + {sin}^{2} ( {h}_{5} ) \} \\ = G 0 * cos ( H 0 ) * \{ {( 1 / 2 )}^{2} * ( 1 + 4 + 1 + 1 + 4 + 1 ) \} \\ = 3 * G 0 * cos ( H 0 )\end{matrix} \qquad ( 54 )$$

Further, when the factor of the orthogonal detection B(k)=cos(hₖ) shown in Expression (55) is set as the factor [1,0,1,−1,0,−1] for finding the inner product H(k) described above similarly to Expression (50), and multiplied by the sampled value y(k), the following Expression (56) can be obtained.

$$\begin{matrix}\begin{matrix}B ( k ) = cos ( {h}_{k} ) \\ = [ B ( 0 ) , B ( 1 ) , B ( 2 ) , B ( 3 ) , B ( 4 ) , B ( 5 ) ] \\ = \sqrt{3} / 2 * [ 1 , 0 , - 1 , - 1 , 0 , 1 ]\end{matrix} & ( 55 ) \\ \begin{matrix}B ( k ) y ( k ) = G 0 * \{ cos ( {h}_{k} ) sin ( {h}_{k} ) cos ( H 0 ) + {cos}^{2} ( {h}_{k} ) \\ sin ( H 0 ) \} * \{ 1 + 2 * g * [ cos ( {h}_{k} ) cos ( H 0 ) - \\ sin ( {h}_{k} ) sin ( H 0 ) ] \} \\ = G 0 * \{ cos ( {h}_{k} ) sin ( {h}_{k} ) cos ( H 0 ) + {cos}^{2} ( {h}_{k} ) sin \\ ( H 0 ) \} + 2 * g * G 0 \{ cos ( {h}_{k} ) sin ( {h}_{k} ) cos ( H 0 ) + \\ {cos}^{2} ( {h}_{k} ) sin ( H 0 ) \} * \{ cos ( {h}_{k} ) cos ( H 0 ) - \\ sin ( {h}_{k} ) sin ( H 0 ) \} \\ = G 0 * \{ cos ( {h}_{k} ) sin ( {h}_{k} ) cos ( H 0 ) + {cos}^{2} ( {h}_{k} ) \\ sin ( H 0 ) \} + 2 * g * G 0 * \{ ( {cos}^{2} ( H 0 ) - {sin}^{2} ( H 0 ) ) * \\ ( sin ( {h}_{k} ) - {sin}^{3} ( {h}_{k} ) ) + sin ( H 0 ) cos ( H 0 ) \\ ( 2 {cos}^{3} ( {h}_{k} ) - cos ( {h}_{k} ) ) \}\end{matrix} & ( 56 )\end{matrix}$$

If the B(k)y(k) is integrated for 6 T/cycle, the integrated value H(k) can be represented by following Expressions (57) to (59).

$$\begin{matrix}H ( k ) = {\int }_{0}^{6 T} B ( k ) y ( k ) \\ = {\int }_{0}^{6 T} G 0 * \{ cos ( {h}_{k} ) sin ( {h}_{k} ) cos ( H 0 ) + {cos}^{2} ( {h}_{k} ) sin ( H 0 ) \} ⅆ k + \\ {\int }_{0}^{6 T} 2 * g * G 0 * \{ ( {cos}^{2} ( H 0 ) - {sin}^{2} ( H 0 ) ) * ( sin ( {h}_{k} ) - {sin}^{3} ( {h}_{k} ) ) \} ⅆ k + \\ {\int }_{0}^{6 T} 2 * g * G 0 * sin ( H 0 ) cos ( H 0 ) ( 2 {cos}^{3} ( {h}_{k} ) - cos ( {h}_{k} ) ) \} ⅆ k & ( 57 ) \\ = G 0 * cos ( H 0 ) {\int }_{0}^{6 T} cos ( {h}_{k} ) sin ( {h}_{k} ) ⅆ k + \\ G 0 * sin ( H 0 ) {\int }_{0}^{6 T} {cos}^{2} ( {h}_{k} ) ⅆ k + \\ 2 * g * G 0 * ( {cos}^{2} ( H 0 ) - {sin}^{2} ( H 0 ) ) {\int }_{0}^{6 T} \{ sin ( {h}_{k} ) - {sin}^{3} ( {h}_{k} ) \} ⅆ k + \\ 2 * g * G 0 * sin ( H 0 ) cos ( H 0 ) {\int }_{0}^{6 T} \{ 2 {cos}^{3} ( {h}_{k} ) - cos ( {h}_{k} ) \} ⅆ k & ( 58 ) \\ = G 0 * sin ( H 0 ) {\int }_{0}^{6 T} {cos}^{2} ( {h}_{k} ) ⅆ k & ( 59 )\end{matrix}$$

As shown in Expressions (57) to (59), the integrated value for 6 T/cycle of cos(hₖ)sin(hₖ) and integrated value for 6 T/cycle of sin(hₖ), sin³(hₖ), cos(hₖ), and cos³ (hₖ) are each zero. Hence, the integrated value H(k) eventually is only the term of the integrated value of cos²(hₖ). Further, the integrated value H(k) for 6 T/cycle is equivalent to the inner product of the sampled values of six points y(k) and the factors B(k) (here, k=0,1,2,3,4,5). Still further, the integrated value H(k) for 6 T/cycle for B(k)y(k) is only the term of the integrated value of cos2 (hₖ) as in Expression (59), and the factor B(k) can be represented by Expression (55) and hence, the integrated value H(k) for 6 T/cycle of B(k)y(k) can be calculated as shown by Expression (60).

$$\begin{matrix}H ( k ) = {\sum }_{i = 0}^{5} B ( i ) y ( i ) \\ = G 0 * sin ( H 0 ) * \{ {cos}^{2} ( {h}_{0} ) + {cos}^{2} ( {h}_{1} ) + {cos}^{2} ( {h}_{2} ) + \\ {cos}^{2} ( {h}_{3} ) + {cos}^{2} ( {h}_{4} ) + {cos}^{2} ( {h}_{5} ) \} \\ = G 0 * sin ( H 0 ) * \{ {( \sqrt{3} / 2 )}^{2} * ( 1 + 0 + 1 + 1 + 0 + 1 ) \} \\ = 3 * G 0 * sin ( H 0 )\end{matrix} \qquad ( 60 )$$

Similarly to the first embodiment, in the preamble area reproducing circuit 1100 of the third embodiment, when the phase shift is minimum, i.e., in the neighborhood of the phase difference H0=0, approximations of cos(H0)=1, and sin(H0)=H0 hold. Therefore, the AGC circuit 1104 finds G(k) from Expression (54), and treats the found G(k) as the amplitude G0, to execute the AGC process based on G(k). In addition, the PLL 1106 finds H(k) based on Expression (60) and treats the found H(k) as the phase difference H0, to execute the PLL process based on H(k).

In the magnetic recording medium according to the third embodiment, the ratio of the width in the track direction of the magnetic portion to the non-magnetic portion in the preamble area 1011 remains 1:1 while a magnetic portion indicating a binary value “1” and a non-magnetic portion indicating a binary value “0” are arranged so that one cycle of the preamble reproduction signal is consisted from “1,1,0,” in other words, two magnetic portions followed by one non-magnetic portion constitute a set and the sets are arranged along the peripheral direction, so that the occupancy of the magnetic portion in the preamble area is approximately 66.7%. Thus, the ratio of depressions/protrusions of the stamper used at the formation of magnetic surface can be made substantially uniform on the entire surface. Hence, the variations in stress that works on the magnetic recording medium at the imprinting is not generated and the manufacturing of the magnetic recording medium can be realized with stable full-imprinting using the stamper.

In addition, since a signal source for the recording of the preamble signals are arranged as to repeat “1,” “1,” and “0” at the fabrication of the stamper during the manufacturing of the magnetic recording medium, the processing for the recording can be remarkably simplified compared with the manufacturing of the conventional magnetic recording medium where the signal source is arranged to repeat “1” and “0.”

In addition, in the magnetic recording medium according to the third embodiment, the magnetic portion indicating “1” and the non-magnetic portion indicating “0” are arranged in the preamble area 1011 so that the preamble reproduction signals for one cycle are “1,1,0,” in other words, two magnetic portions and one non-magnetic portion form a set corresponding to one cycle and the plural sets are sequentially arranged. The preamble reproduction signal must be sampled six times for each cycle for both the AGC process and the PLL process. The longitudinal equalization signal without degraded signal to noise ratio can be obtained. Hence, the decrease in the yield when such magnetic recording medium according to the third embodiment is used as a hard disk can be prevented.

A preamble area reproducing circuit in a magnetic recording/reproducing apparatus according to a fourth embodiment performs a process closer to the orthogonal detection as a separate processor that serves as a phase amplitude detector and performs a calculating process of an inner product of the sampled values and the loop factors executed in the AGC circuit or the PLL. Here, the magnetic recording/reproducing apparatus according to the third embodiment reproduces data from the magnetic recording medium according to the third embodiment.

FIG. 15 is a block diagram of a structure of a preamble area reproducing circuit 1500 according to the fourth embodiment. The preamble area reproducing circuit 1500 according to the fourth embodiment includes, as shown in FIG. 15, an equalizer 1501, a VGA 1502, an AD converter 1503, an AGC circuit 1504, an SFG 1505, a PLL 1506, and a phase amplitude detector 1507. Here, the equalizer 1501, the VGA 1502, the AD converter 1503, and the SFG 1505 have the same function as the corresponding circuits in the preamble area reproducing circuit 1100 according to the third embodiment.

The phase amplitude detector 1507 performs a calculating operation of the inner product of sampled values at six points of the preamble reproduction signal and the loop factors A(k) and B(k) described later, and detects the reproduction amplitude and the phase difference of the preamble signal from the calculated inner product. The detail of the phase amplitude detector 1507 is described later.

The PLL 1506 (phase adjusting unit) adjusts the phase of the servo reference clock generated by the SFG 1105 based on the phase difference detected by the phase amplitude detector 1507. The PLL 1506 generates a reproduction clock that has the same N-time cycle and phase with the preamble reproduction signal detected by the AD converter 1503 to realize an appropriate sampling timing for the AD conversion by the AD converter 1501.

The AGC converter 1504 (gain controlling unit) controls the gain of the VGA 1102 based on the amplitude detected by the phase amplitude detector 1507.

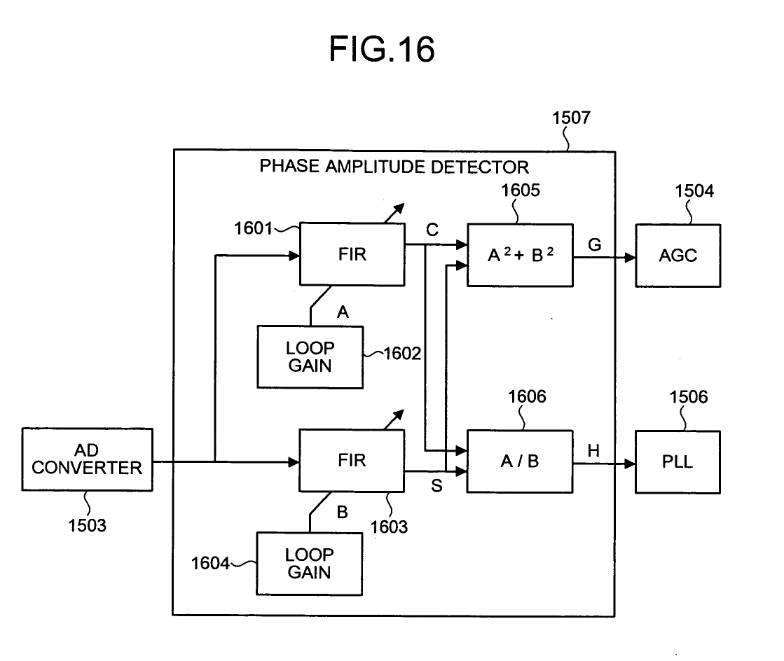

Next, the details of the phase amplitude detector 1507 are described. FIG. 16 is a block diagram of a structure of the phase amplitude detector 1507. The phase amplitude detector 1507, as shown in FIG. 16, includes FIRs 1601 and 1603, and computing units 1605 and 1606.

The FIRs 1601 and 1603 are filters with six taps that further equalizes the preamble reproduction signal after conversion into a digital form by the AD converter 1503.

The computing unit 1605 calculates a sum of squares (A²+B²), whereas the computing unit 1606 performs division (A/B).

The sampled value output from the AD converter 1503 is supplied to two FIRs 1601 and 1603 and delivered. The FIRs 1601 and 1603, on receiving the sampled values, stores the input sampled values by an inner delay element, to perform calculation as represented by Expression (61) and perform the operation equivalent to storing the sampled values on six points.
Out(k)=g0*y(k)+g1*y(k−1)+g2*y(k−2)+g3*y(k−3)+g4*y(k−4)+g5*y(k−5) (61)

An ordinary FIR filter has factors g0-g5 which are fixed values. The FIR 1601 of the fourth embodiment uses a loop gain 1602 to obtain such factors g0-g5. Whenever the sampled value on k time is acquired, the FIR 1601 adds a loop delay to the factor A(k) and calculates the inner product according to Expression (61). The loop gain 1602 is represented by Expression (62) similarly to the third embodiment.

Further, the FIR 1603 uses a loop gain 1604 to obtain factors g0-g5. The FIR 1603, on receiving the sampled value at k time, adds a loop delay to the factors and calculates the inner product according to Expression (61). The loop gain 1604 is represented by Expression (63) similarly to the third embodiment.

$$\begin{matrix}\begin{matrix}A ( k ) = sin ( ( 2 k + 1 ) π / 6 ) \\ = [ A ( 0 ) , A ( 1 ) , A ( 2 ) , A ( 3 ) , A ( 4 ) , A ( 5 ) ] \\ = ( 1 / 2 ) * [ 1 , 2 , 1 , - 1 , - 2 , - 1 ]\end{matrix} & ( 62 ) \\ \begin{matrix}B ( k ) = cos ( ( 2 k + 1 ) π / 6 ) \\ = [ B ( 0 ) , B ( 1 ) , B ( 2 ) , B ( 3 ) , B ( 4 ) , B ( 5 ) ] \\ = \sqrt{3} / 2 * [ 1 , 0 , - 1 , - 1 , 0 , 1 ]\end{matrix} & ( 63 )\end{matrix}$$

Here, the loop delay of the factor A(k) in the loop gain 1602 is set so that the factor A(k) sequentially changes as [1,2,1,−1,−2,−1], [2,1,−1,−2,−1,1], [1,−1,−2,−1,1,2], [−1,−2,−1,1,2,1], [−2,−1,1,2,1,−1], [−1,1,2,1,−1,−2], [1,2,1,−1,−2,−1] according to the update of the sample point k similarly to the third embodiment.

Further, the loop delay of the factor B(k) in the loop gain 1604 is set so that the factor A(k) sequentially changes such as [1,0,−1,−1,0,1], [0,−1,−1,0,1,1], [−1,−1,0,1,1,0], [−1,0,1,1,0,−1], (½)*[0,1,1,0,−1,−1,0], [1,1,0,−1,−1,0], [1,0,−1,−1,0,0] according to the update of the sample point k similarly to the third embodiment.

An output C(k) is obtained via the calculation of Expression (61) on the factor A(k) and the sampled value y(k), and an output S(k) is obtained via the calculation of Expression (61) on the factor B(k) and the sampled value y(k). Here, in the conventional preamble area reproducing circuit, such output C(k) is treated as an amplitude and output S(k) as a phase difference. In the fourth embodiment, however, C(k), and S(k) are represented by Expressions (64) and (65) as derived according to Expressions (54) and (60).
C(k)=3*G0*cos(H0) (64)
S(k)=3*G0*sin(H0) (65)

Hence, the amplitude G(k) is found via the calculation of the sum of square of the detected C(k) and the detected S(k) by the computing unit 1605 as shown by Expression (66), and the phase difference H(k) is found via the division of S(k) by C(k) by the computing unit 1606 as shown by Expression (67).
G(k)=C²(k)+S²(k)=9*G0² (66)
H(k)=S(k)/C(k)=tan(H0) (67)

Here, though the amplitude G(k) calculated according to Expression (66) is a square of the amplitude G0, a desired amplitude at which the AGC process is to be performed is set to be (square of G0)*9.

In addition, the phase difference H(k) calculated according to Expression (67) is represented with tan(H0). Hence, when H0 is in the neighborhood of zero, more precise value of the phase difference can be obtained than is expressed by Expression using sin(H0).

Thus, in the preamble area reproducing circuit 1500 according to the fourth embodiment, the calculation of the inner product of the sampled value of the preamble reproduction signal and the factor of the loop gains 1602 and 1604 is realized by the phase amplitude detector 1507, whereby the process closer to the orthogonal detection can be achieved and more precise calculation of the amplitude and the phase difference is allowed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A magnetic recording medium comprising:
a servo area including a preamble area where a magnetic portion and a non-magnetic portion for clock synchronization are formed; and
a data area where user data is written into, wherein
the magnetic portion is different in an occupancy to the preamble area from the non-magnetic portion.

2. The magnetic recording medium according to claim 1, wherein
the data area includes a user data writable magnetic portion and a user data unwritable non-magnetic portion, and
a difference between an occupancy of the magnetic portion in the preamble area and an occupancy of the magnetic portion in the data area is within a range of 10%.

3. The magnetic recording medium according to claim 2, wherein
a ratio of the magnetic portion to the non-magnetic portion in the data area is 2:1, and
a ratio of width in a track direction of the magnetic portion to the non-magnetic portion in the preamble area is 2:1.

4. The magnetic recording medium according to claim 2, wherein
a ratio of the magnetic portion to the non-magnetic portion in the data area is 1:2, and
a ratio of width in a track direction of the magnetic portion to the non-magnetic portion in the preamble area is 1:2.

5. The magnetic recording medium according to claim 1, wherein
the magnetic portion and the non-magnetic portion in the preamble area are formed so that a cycle length of a servo data reproduction signal from the preamble area is equal to or longer than 1.5 times a cycle length of a servo data reproduction signal from areas outside the preamble area in the servo area.

6. The magnetic recording medium according to claim 5, wherein
the magnetic portion and the non-magnetic portion are repeatedly arranged in the preamble area so that a pattern of “the magnetic portion, the magnetic portion, the non-magnetic portion” is formed.

7. A magnetic recording/reproducing apparatus for reproducing data from a magnetic recording medium which includes a servo area having a preamble area where servo data for clock synchronization is recorded; and a data area where user data can be written into via a magnetic head, the magnetic recording/reproducing apparatus comprising:
an analog-digital converting unit configured to convert an analog preamble reproduction signal into a digital preamble reproduction signal by taking sampled values at six points in one cycle of the analog preamble reproduction signal reproduced from the preamble area at a generation timing of a servo reference clock;
a phase adjusting unit configured to detect a phase difference of the analog preamble reproduction signal based on the sampled values taken at six points by the analog-digital converting unit, and configured to adjust a phase of the servo reference clock based on the detected phase difference to adjust a sampling timing of the analog-digital converting unit; and
a gain controlling unit configured to detect an amplitude of the analog preamble reproduction signal based on the sampled values taken at six points by the analog-digital converting unit, and configured to control a gain of the analog preamble reproduction signal based on the detected amplitude.

8. The magnetic recording/reproducing apparatus according to claim 7, wherein
the servo data is recorded in the preamble area of the magnetic recording medium so that a difference between an occupancy of the magnetic portion in the preamble area and an occupancy of the magnetic portion in the data area is within a range of 10%, and the magnetic portion and the non-magnetic portion are formed so that a cycle length of a servo data reproduction signal from the preamble area is equal to or longer than 1.5 times a cycle length of a servo data reproduction signal from areas outside the preamble area in the servo area.

9. The magnetic recording/reproducing apparatus according to claim 7, wherein
the phase adjusting unit is configured to calculate an inner product of the six sampled values and six first factors predetermined respectively for sample points, detects a phase difference of the analog preamble reproduction signal from the inner product, adjusts a phase of a servo reference clock based on the detected phase difference, and adjusts the sampling timing of the analog-digital converting unit, and
the gain controlling unit is configured to calculate an inner product of the six sampled values and six second factors predetermined respectively for the sample points, detects an amplitude of the analog preamble reproduction signal from the inner product, and controls the gain of the analog preamble reproduction signal based on the detected amplitude.

10. The magnetic recording/reproducing apparatus according to claim 9, wherein
the phase adjusting unit, on receiving a sampled value at each sample point, sequentially adds loop delay to the six first factors, calculates an inner product of the six sampled values including the latest acquired sampled value and the six first factors obtained via the loop delay, detects the phase difference of the analog preamble reproduction signal from the inner product, adjusts the phase of the servo reference clock based on the detected phase difference, and adjusts the sampling timing of the analog-digital converting unit,
the gain controlling unit, on receiving a sampled value at each sample point, sequentially adds loop delay to the six second factors, calculates an inner product of the six sampled values including the latest acquired sampled value and the six second factors obtained via the loop delay, detects the amplitude of the analog preamble reproduction signal from the inner product, and controls the gain of the analog preamble reproduction signal based on the detected amplitude.

11. The magnetic recording/reproducing apparatus according to claim 9, further comprising
a phase amplitude detecting unit which, on receiving a sampled value at each sample point, sequentially adds loop delay to the six first factors, calculates a first inner product of the six sampled values including the latest acquired sampled value and the six first factors obtained via the loop delay and detects the phase difference of the analog preamble reproduction signal from the first inner product, as well as, on receiving a sampled value at each sample point, sequentially adds loop delay to the six second factors, calculates a second inner product of the six sampled values including the latest acquired sampled value and the six second factors obtained via the loop delay, and detects the amplitude of the analog preamble reproduction signal from the second inner product, wherein
the phase adjusting unit is configured to adjust the phase of the servo reference clock based on the phase difference detected by the phase amplitude detecting unit, and is configured to adjust the sampling timing of the analog-digital converting unit, and
the gain controlling unit is configured to control the gain of the analog preamble reproduction signal based on the amplitude detected by the phase amplitude detecting unit.

12. A stamper for manufacturing a magnetic recording medium, comprising
an area with a depression and a protrusion, the area corresponding to a preamble area having a magnetic portion and a non-magnetic portion which represent servo data for clock synchronization of the magnetic recording medium, wherein
an occupancy of the depression is different from an occupancy of the protrusion.

13. The stamper for manufacturing a magnetic recording medium according to claim 12, wherein
the stamper includes an area with a depression and a protrusion, the area corresponding to a data area having a magnetic portion where user data can be written into and a non-magnetic portion where user data cannot be written into, and a difference between an occupancy of the depression to the protrusion in the area corresponding to the preamble area and an occupancy of the depression to the protrusion in the area corresponding to the data area is within a range of 10%.
